(19) United States
(12) Patent Application Publication
(10) Pub. No.: US 2026/0211672 A1
(43) Pub. Date: Jul. 23, 2026

(54) AUTOMATICALLY GENERATING CONTEXT-BASED SYSTEM-RELATED DOCUMENTATION USING ARTIFICIAL INTELLIGENCE TECHNIQUES

(71) Applicant: Dell Products L.P., Round Rock, TX (US)

(72) Inventors: Bijan Kumar Mohanty, Austin, TX (US); David J. Linsey, Marietta, GA (US); Hung T. Dinh, Austin, TX (US)

(21) Appl. No.: 19/032,310

(22) Filed: Jan. 20, 2025

(51) Int. Cl. G06F 8/73; G06F 40/186

(52) U.S. Cl. CPC G06F 8/73; G06F 40/186

(57) ABSTRACT

Methods, apparatus, and processor-readable storage media for automatically generating context-based system-related documentation using artificial intelligence techniques are provided herein. An example computer-implemented method includes obtaining at least one system-related documentation generation request; identifying one or more context-based features of the system-related documentation generation request(s); determining one or more documentation templates, and one or more data objects corresponding thereto, to be used in documentation generation by processing, using a first set of artificial intelligence techniques, at least a portion of the system-related documentation generation request(s) and at least a portion of the context-based feature(s); generating documentation in response to the system-related documentation generation request(s) by using at least a portion of the documentation template(s) and at least a portion of the data object(s) corresponding thereto in conjunction with a second set of artificial intelligence techniques; and performing one or more automated actions based on the generated documentation.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

System-related documentation generation, particularly with respect to more complex documentation that pertains to hardware, software and related services, commonly presents challenges. For example, conventional documentation generation techniques often rely on resource-intensive methods which can be error-prone and latency-inducing for systems and users thereof.

### SUMMARY

Illustrative embodiments of the disclosure provide techniques for automatically generating context-based system-related documentation using artificial intelligence techniques.

An exemplary computer-implemented method includes obtaining at least one system-related documentation generation request, and identifying one or more context-based features of the at least one system-related documentation generation request. The method also includes determining one or more documentation templates, and one or more data objects corresponding thereto, to be used in connection with documentation generation by processing, using a first set of one or more artificial intelligence techniques, at least a portion of the at least one system-related documentation generation request and at least a portion of the one or more context-based features. Further, the method additionally includes generating documentation in response to the at least one system-related documentation generation request by using at least a portion of the one or more documentation templates and at least a portion of the one or more data objects corresponding thereto in conjunction with a second set of one or more artificial intelligence techniques, and performing one or more automated actions based at least in part on the generated documentation.

Illustrative embodiments can provide significant advantages relative to conventional documentation generation techniques. For example, problems associated with errors and latencies arising from resource-intensive conventional methods are overcome in one or more embodiments through automatically recommending templates and corresponding data objects for use in automated documentation generation using artificial intelligence techniques.

These and other illustrative embodiments described herein include, without limitation, methods, apparatus, systems, and computer program products comprising processor-readable storage media.

### BRIEF DESCRIPTION OF THE DRAWINGS

FIG. 1 shows an information processing system configured for automatically generating context-based system-related documentation using artificial intelligence techniques in an illustrative embodiment.

FIG. 2 shows example system architecture in an illustrative embodiment.

FIG. 3 shows example neural network architecture in an illustrative embodiment.

FIG. 4 shows example pseudocode for data preprocessing in an illustrative embodiment.

FIG. 5 shows example pseudocode for encoding categorical features and splitting data in an illustrative embodiment.

FIG. 6 shows example pseudocode for standardizing feature data in an illustrative embodiment.

FIG. 7 shows example pseudocode for configuring a neural network model in an illustrative embodiment.

FIG. 8 shows example pseudocode for compiling and training the neural network model in an illustrative embodiment.

FIG. 9 shows example pseudocode for evaluating and implementing the neural network model in an illustrative embodiment.

FIG. 10 shows example pseudocode for installing a large language model (LLM) library in an illustrative embodiment.

FIG. 11 shows example pseudocode for importing an LLM and application programming interface (API) key value in an illustrative embodiment.

FIG. 12 shows example pseudocode for defining the documentation template in a tabular format in an illustrative embodiment.

FIG. 13 shows example pseudocode for converting the LLM dictionary to a data frame in an illustrative embodiment.

FIG. 14 shows example pseudocode for building case details sections of documentation in an illustrative embodiment.

FIG. 15 shows example pseudocode for generating an LLM prompt in an illustrative embodiment.

FIG. 16 shows example pseudocode for generating and printing the documentation in an illustrative embodiment.

FIG. 17 is a flow diagram of a process for automatically generating context-based system-related documentation using artificial intelligence techniques in an illustrative embodiment.

FIGS. 18 and 19 show examples of processing platforms that may be utilized to implement at least a portion of an information processing system in illustrative embodiments.

### DETAILED DESCRIPTION

Illustrative embodiments will be described herein with reference to exemplary computer networks and associated computers, servers, network devices or other types of processing devices. It is to be appreciated, however, that these and other embodiments are not restricted to use with the particular illustrative network and device configurations shown. Accordingly, the term “computer network” as used herein is intended to be broadly construed, so as to encompass, for example, any system comprising multiple networked processing devices.

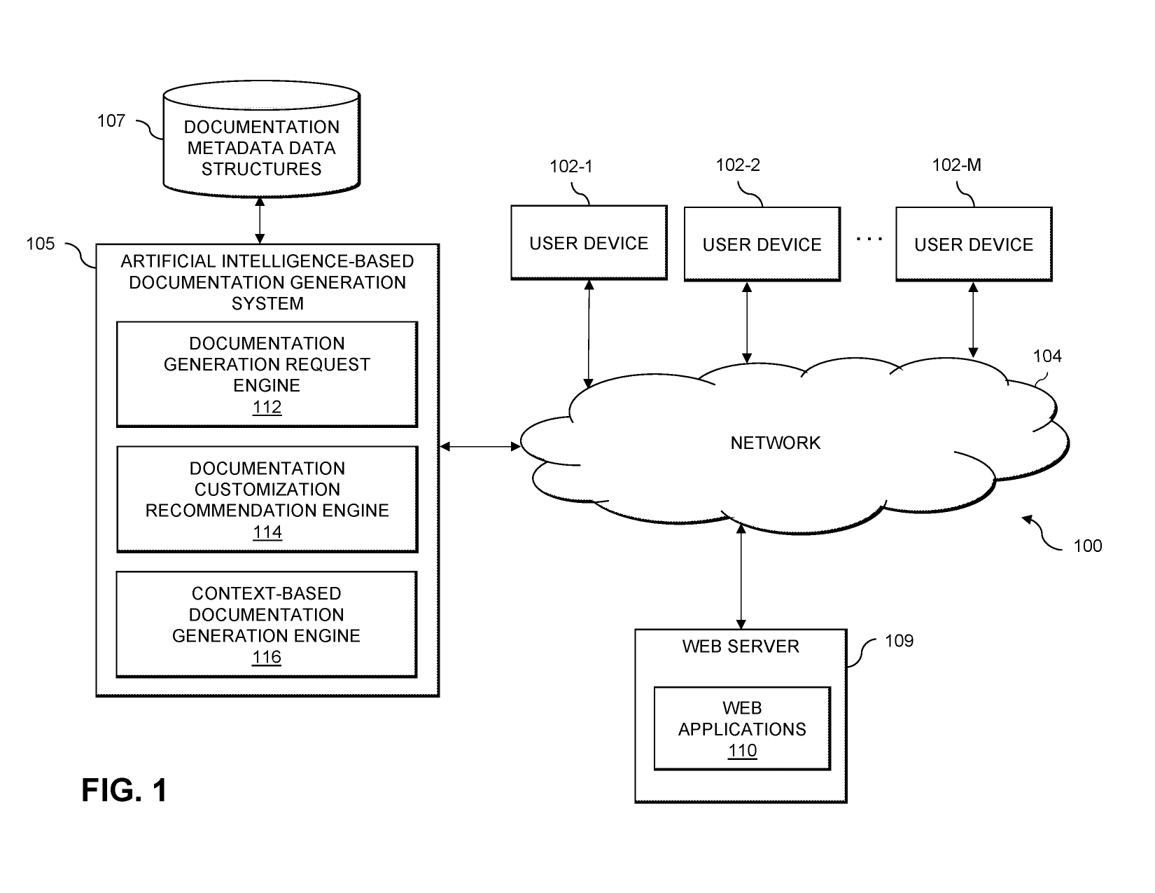

FIG. 1 shows a computer network (also referred to herein as an information processing system) 100 configured in accordance with an illustrative embodiment. The computer network 100 comprises a plurality of user devices 102-1, 102-2, . . . 102-M, collectively referred to herein as user devices 102. The user devices 102 are coupled to a network 104, where the network 104 in this embodiment is assumed to represent a sub-network or other related portion of the larger computer network 100. Accordingly, elements 100 and 104 are both referred to herein as examples of “networks” but the latter is assumed to be a component of the former in the context of the FIG. 1 embodiment. Also coupled to network 104 is artificial intelligence-based documentation generation system 105 and web server 109, upon which one or more web applications 110 (e.g., one or more hardware support applications, one or more software support applications, one or more e-commerce applications, etc.) execute.

The user devices 102 may comprise, for example, mobile telephones, laptop computers, tablet computers, desktop computers or other types of computing devices. Such devices are examples of what are more generally referred to herein as “processing devices.” Some of these processing devices are also generally referred to herein as “computers.”

The user devices 102 in some embodiments comprise respective computers associated with a particular company, organization or other enterprise. In addition, at least portions of the computer network 100 may also be referred to herein as collectively comprising an “enterprise network.” Numerous other operating scenarios involving a wide variety of different types and arrangements of processing devices and networks are possible, as will be appreciated by those skilled in the art.

Also, it is to be appreciated that the term “user” in this context and elsewhere herein is intended to be broadly construed so as to encompass, for example, human, hardware, software or firmware entities, as well as various combinations of such entities.

The network 104 is assumed to comprise a portion of a global computer network such as the Internet, although other types of networks can be part of the computer network 100, including a wide area network (WAN), a local area network (LAN), a satellite network, a telephone or cable network, a cellular network, a wireless network such as a Wi-Fi or WiMAX network, or various portions or combinations of these and other types of networks. The computer network 100 in some embodiments therefore comprises combinations of multiple different types of networks, each comprising processing devices configured to communicate using internet protocol (IP) or other related communication protocols.

Additionally, the artificial intelligence-based documentation generation system 105 can have one or more documentation metadata data structures 107 configured to store data pertaining to documentation formats, documentation data objects, etc. The term “data structure,” as used herein, is intended to be broadly construed, so as to encompass, for example, a wide variety of different types of tables, arrays, graphs, trees, linked lists, and additional or alternative data relation mechanisms, as well as portions or combinations thereof. Accordingly, a given data structure can comprise a combination of multiple smaller data structures, possibly of different types, or a portion of a larger data structure. Numerous other arrangements are possible.

The documentation metadata data structures 107 in the present embodiment are implemented using one or more storage systems associated with the artificial intelligence-based documentation generation system 105. Such storage systems can comprise any of a variety of different types of storage including network-attached storage (NAS), storage area networks (SANs), direct-attached storage (DAS) and distributed DAS, as well as combinations of these and other storage types, including software-defined storage.

Also associated with the artificial intelligence-based documentation generation system 105 are one or more input-output devices, which illustratively comprise keyboards, displays or other types of input-output devices in any combination. Such input-output devices can be used, for example, to support one or more user interfaces to the artificial intelligence-based documentation generation system 105, as well as to support communication between the artificial intelligence-based documentation generation system 105 and other related systems and devices not explicitly shown.

Additionally, the artificial intelligence-based documentation generation system 105 in the FIG. 1 embodiment is assumed to be implemented using at least one processing device. Each such processing device generally comprises at least one processor and an associated memory, and implements one or more functional modules for controlling certain features of the artificial intelligence-based documentation generation system 105.

More particularly, the artificial intelligence-based documentation generation system 105 in this embodiment can comprise a processor coupled to a memory and a network interface.

The processor may comprise, for example, a microprocessor, an application-specific integrated circuit (ASIC), a system-on-chip (SOC), a field-programmable gate array (FPGA), a central processing unit (CPU), a graphics processing unit (GPU), a neural processing unit (NPU), a data processing unit (DPU), a tensor processing unit (TPU), an arithmetic logic unit (ALU), a digital signal processor (DSP), and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory illustratively comprises random access memory (RAM), read-only memory (ROM) or other types of memory, in any combination. The memory and other memories disclosed herein may be viewed as examples of what are more generally referred to as “processor-readable storage media” storing executable computer program code or other types of software programs.

One or more embodiments include articles of manufacture, such as computer-readable storage media. Examples of an article of manufacture include, without limitation, a storage device such as a storage disk, a storage array or an integrated circuit containing memory, as well as a wide variety of other types of computer program products. The term “article of manufacture” as used herein should be understood to exclude transitory, propagating signals. These and other references to “disks” herein are intended to refer generally to storage devices, including solid-state drives (SSDs), and should therefore not be viewed as limited in any way to spinning magnetic media.

The network interface allows the artificial intelligence-based documentation generation system 105 to communicate over the network 104 with the user devices 102, and illustratively comprises one or more conventional transceivers.

The artificial intelligence-based documentation generation system 105 further comprises a documentation generation request engine 112, a documentation customization recommendation engine 114, and a context-based documentation generation engine 116.

As further detailed herein, in one or more embodiments, the documentation generation request engine 112 can be implemented to process at least one system-related documentation generation request, and identify one or more context-based features of the at least one system-related documentation generation request. Also, in such an embodiment, the documentation customization recommendation engine 114 can be implemented to determine and recommend one or more documentation templates, and one or more data objects corresponding thereto, to be used in connection with documentation generation by processing, using a first set of one or more artificial intelligence techniques, at least a portion of the at least one system-related documentation generation request and at least a portion of the one or more context-based features. Further, in such an embodiment, the context-based documentation generation engine 116 can be implemented to generate documentation in response to the at least one system-related documentation generation request by using at least a portion of the one or more documentation templates and at least a portion of the one or more data objects corresponding thereto in conjunction with a second set of one or more artificial intelligence techniques.

It is to be appreciated that this particular arrangement of elements 112, 114 and 116 illustrated in the artificial intelligence-based documentation generation system 105 of the FIG. 1 embodiment is presented by way of example only, and alternative arrangements can be used in other embodiments. For example, the functionality associated with elements 112, 114 and 116 in other embodiments can be combined into a single module, or separated across a larger number of modules. As another example, multiple distinct processors can be used to implement different ones of elements 112, 114 and 116 or portions thereof.

At least portions of elements 112, 114 and 116 may be implemented at least in part in the form of software that is stored in memory and executed by a processor.

It is to be understood that the particular set of elements shown in FIG. 1 for automatically generating context-based system-related documentation using artificial intelligence techniques involving user devices 102 of computer network 100 is presented by way of illustrative example only, and in other embodiments additional or alternative elements may be used. Thus, another embodiment includes additional or alternative systems, devices and other network entities, as well as different arrangements of modules and other components. For example, in at least one embodiment, two or more of artificial intelligence-based documentation generation system 105, documentation metadata data structures 107, and web server 109 can be on and/or part of the same processing platform.

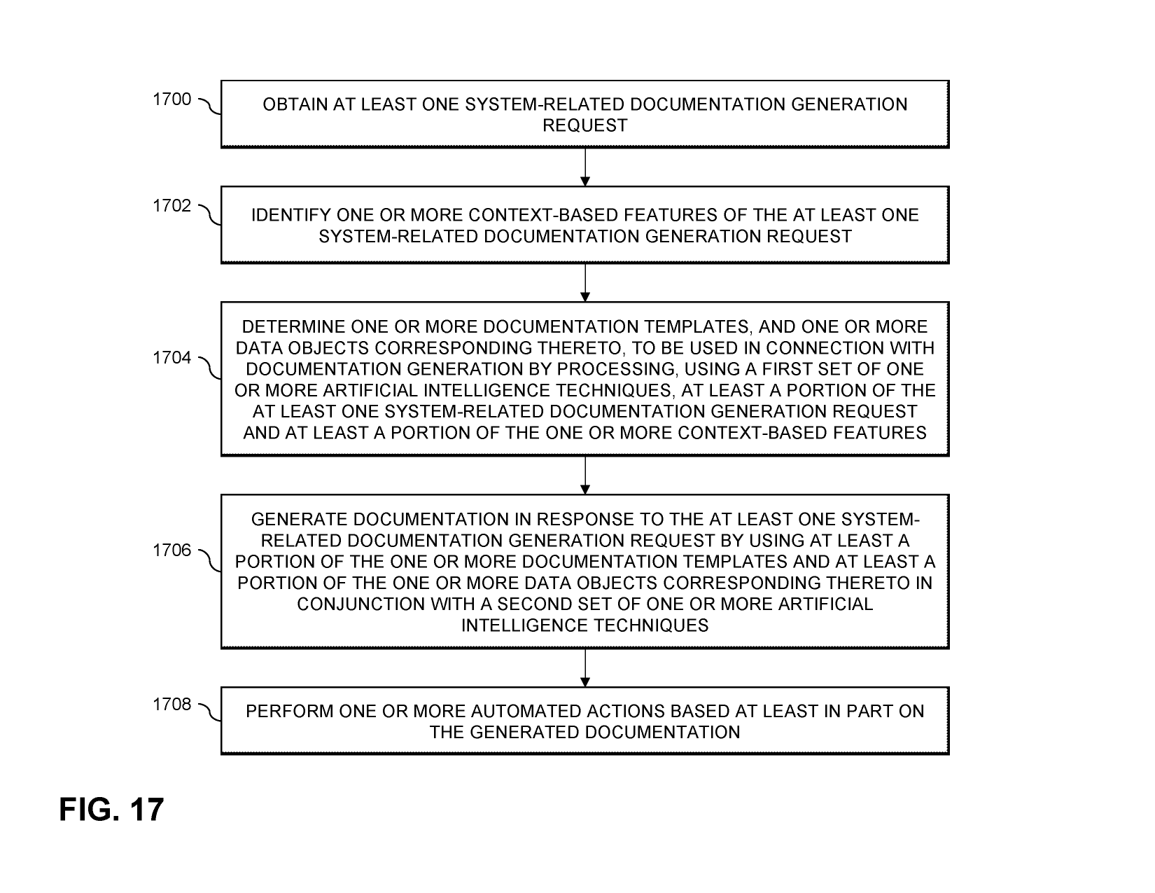

An exemplary process utilizing elements 112, 114 and 116 of an example artificial intelligence-based documentation generation system 105 in computer network 100 will be described in more detail with reference to the flow diagram of FIG. 17.

Accordingly, at least one embodiment includes generating and/or implementing a dynamic documentation generation framework with personalized recommendations for systems and/or users thereof. As further detailed herein, such an embodiment includes enhancing automated documentation generation by providing artificial intelligence-based contextual documentation suggestions, artificial intelligence-based reuse of individual reporting templates and/or data objects, and pressure testing of generated documentation via backcasting of existing documentation. As used herein, documentation generally refers to text and/or graphical content pertaining to one or more designated topics and/or elements. Documentation, as used herein, can include, by way merely of example, electronic documentation, such as electronic documents, web pages, etc.

More particularly, one or more embodiments include determining intelligent, contextually relevant, documentation generation suggestions based at least in part on the user and system in question. Also, such an embodiment includes implementing assisted reuse of documentation objects (e.g., data cubes) which drive existing documentation as new documentation is generated, and backcasting newly defined documentation objects against existing documentation objects to identify possible existing duplication. Further, such an embodiment can additionally include dynamically generating custom and/or context-based documentation by leveraging generative artificial intelligence (GenAI) and retrieval augmented generation (RAG) techniques.

Accordingly, at least one embodiment includes generating and/or implementing an artificial intelligence-based documentation generation system that identifies and recommends user-specific report templates from at least one historical reports database pertaining to similar users. More particularly, such an embodiment can include proposing documentation structure with one or more sections and one or more data objects that can be reused, which facilitates consistency in documentation quality and structure while allowing for customization based at least in part on individual user profiles and/or preferences. By reusing proven documentation structures and relevant data objects, time and resources are saved, as components of the documentation are already validated and optimized for similar use cases.

As used herein, a data object refers generally to any type of fact and/or data on which a system has been trained. By way merely of example, a data object might include information from one or more reports, such as ship dates of orders, case number, status, device and/or component age, software version information, etc.

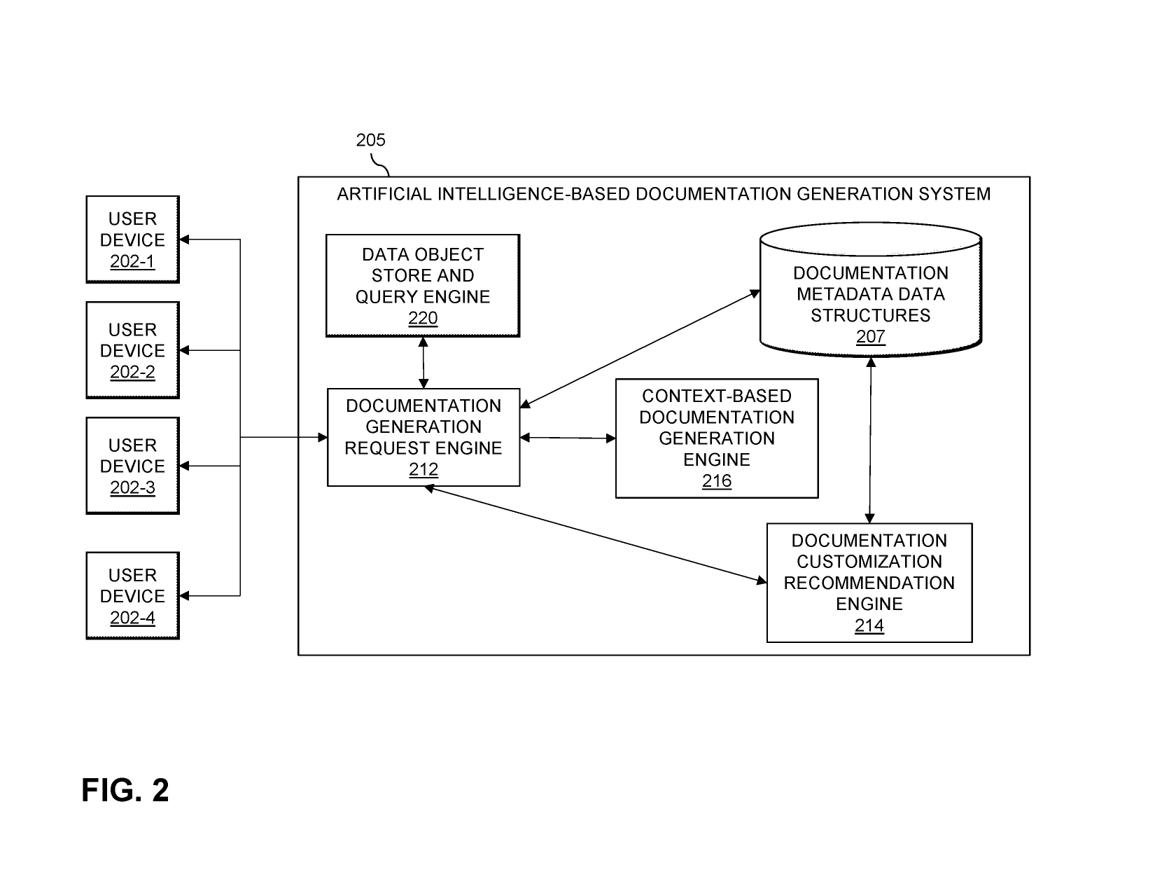

FIG. 2 shows example system architecture in an illustrative embodiment. By way of illustration, FIG. 2 depicts user devices 202-1, 202-2, 202-3 and 202-4 (collectively referred to as user devices 202), interacting with artificial intelligence-based documentation generation system 205. More particularly, requests for documentation are passed from user devices 202 to documentation generation request engine 212, which implements a workflow that validates the entitlement of the corresponding user device and/or user associated therewith. Upon successful validation of the entitlement, the workflow will identify if there is similar existing documentation (e.g., documentation describing one or more similar requests and/or user needs) associated with one or more other users available. This can be carried out using the documentation customization recommendation engine 214, which can process request information provided by the documentation generation request engine 212 and suggest documentation format information and one or more data objects to be used in such documentation. Such suggestions are then provided back to the documentation generation request engine 212. As also illustrated in FIG. 2, the documentation customization recommendation engine 214 can be trained using data from documentation metadata data structures 207.

The workflow associated with documentation generation request engine 212 then includes accessing data object store and query engine 220 to obtain data in accordance with the suggestions generated by documentation customization recommendation engine 214. Such data can include one or more documentation templates which are consistent with the formatting suggestion(s) generated by documentation customization recommendation engine 214, and/or one or more data objects suggested by documentation customization recommendation engine 214. The data retrieved from the data object store and query engine 220 can then be processed and provided, along with the request information, to context-based documentation generation engine 216, which will automatically generate documentation in response to the request and utilizing the formatting information and one or more data objects provided thereto. In one or more embodiments, recommended formatting information can be based at least in part on the training information provided (e.g., tabular formatting information, graphical formatting information, text-related formatting information, etc.). The generated documentation can then be output to at least one of the user devices 202 via documentation generation request engine 212. Further, metadata attributed to the generated documentation (e.g., formatting information and one or more data objects) can be provided to and/or stored in documentation metadata data structures 207 to be used, for example, to further train artificial intelligence techniques within the document customization recommendation engine 214.

In connection with documentation metadata data structures 207 and document customization recommendation engine 214 identifying formatting information and/or data objects to be recommended for use in customized automated document generation, consider example types of documentation which may exist within a given ecosystem, and can be used at least in part to train at least a portion of document customization recommendation engine 214. For instance, such example types of documentation can include new order purchases, which can include identification of system purchases (e.g., specific hardware, specific software, specific related services, etc.), user account information, fulfillment information, estimated delivery dates, on-site deployment and/or installation information, etc. Additionally, example types of documentation can include support case overviews, which can include an overview of recent support cases for system components in at least one particular ecosystem, including system pertaining to system component aging, issue root causes, resolutions, etc. Further, example types of documentation can include software patch level reports, which can include an overview of the patch level of various pieces of software being run as a standalone and/or present on hardware. Further still, example types of documentation can include system monitoring health data reports, which can include health monitoring information and/or metrics related to one or more particular systems and/or components thereof.

In addition to example types of documentation that can be contained within documentation metadata data structures 207, example user profile information associated with documentation requests can also be stored in documentation metadata data structures 207 and used at least in part to train at least a portion of document customization recommendation engine 214. For instance, such example user profiles can include identifications of user segment and/or industry, user interests and/or needs associated with documentation requests, types of documentation formats and/or templates used for particular users in response to previous documentation requests, etc.

Accordingly, one or more embodiments include leveraging modular documentation templates, wherein each template can be seen and/or treated as a modular component that focuses on at least one specific aspect of the documentation. For example, one template might focus on presenting an overview, another template might focus on presenting a detailed analysis, and yet another template might focus on presenting one or more visual representations (e.g., charts, graphs, etc.). Such templates can be designed to integrate with each other, and to be reused and/or modified as part of new and/or additional documentation.

Additionally, as detailed herein, at least one embodiment includes leveraging shared data objects, which hold actual metadata of content or data (e.g., sales figures, performance metrics, user satisfaction scores, etc.) that may be needed to populate one or more templates. Such an embodiment can also include assembling one or more templates which can include, e.g., combining sections from multiple templates, wherein each template uses the same or different data objects but potentially displaying such data objects differently (e.g., tables, graphs, summaries, etc.). This creates a cohesive item of documentation wherein each section emphasizes one or more different interpretations of the data. Such documentation can also have one or more sections containing other value-added details for the user (e.g., insights can be added by leveraging GenAI techniques).

This framework facilitates the automated generation of user-specific documentation, composed of one or more contextually relevant templates and one or more related data objects. By leveraging multiple templates with multiple data objects, one or more embodiments can include generating well-structured, multi-section documentation that presents similar core data in various formats, ensuring clarity, depth, and versatility.

Referring again to FIG. 2, documentation generation request engine 212 can implement a workflow which includes receiving documentation requests from users (via user devices 202) along with one or more request details (e.g., user industry, user size, user region, associated system components, documentation type, etc.). At least a portion of such details can be used to request the document customization recommendation engine 214 to identify and/or recommend existing documentation and/or portions thereof with similarity matches with respect to the user and/or the documentation request. Once the recommended documentation information is received from the document customization recommendation engine 214, the workflow of the documentation generation request engine 212 can proceed by utilizing recommended format information and one or more data objects to retrieve the corresponding data. The documentation generation request engine 212 then passes such retrieved data, and request information, to the context-based documentation generation engine 216, which will dynamically generate the user-specific documentation and return the same to the user via the documentation generation request engine 212.

Also, documentation metadata data structures 207, as detailed above and herein, contain documentation metadata which can be used as training data for document customization recommendation engine 214 and/or context-based documentation generation engine 216. Existing documentation, including their formats and data objects, can be managed in the documentation metadata data structures 207 along with user and relevant system details. By way of example, in at least one embodiment, such metadata can be used to train at least a portion of the document customization recommendation engine 214, including at least one deep neural network-based (DNN-based) multi-target classifier. Such a neural network is trained to predict appropriate documentation and/or portions thereof for a new and/or input user request.

More particularly, in such an embodiment, the document customization recommendation engine 214 leverages at least one DNN-based classifier to predict suitable documentation templates and associated data objects for user documentation requests, based at least in part on corresponding user profiles and request-related details. By analyzing historical data of previously generated documentation and corresponding user profiles, the at least one DNN-based classifier can learn patterns and/or relationships between user characteristics and the structure of various forms of documentation. For example, when a new documentation request is received, the at least one DNN-based classifier processes the request and predicts at least one appropriate documentation template and corresponding data objects by evaluating how similar users with similar requests (represented by metadata in the documentation metadata data structures 207) have been served in the past. Such an automated prediction reduces the need for manual documentation customization and enables the reuse of validated templates and data objects, while providing personalized and contextually relevant documentation for each user’s unique needs.

To support such predictions and/or recommendations, at least one embodiment includes implementing a multi-output, multi-label classification. Such an embodiment includes implementing a machine learning technique which is trained to predict multiple target variables (i.e., outputs), wherein each of the target variables can have multiple possible labels (i.e., classes) simultaneously. In the context of user-specific documentation generation, one or more embodiments include predicting and/or recommending one or more documentation templates and one or more corresponding data objects needed to fulfill a user’s documentation requirements. Because each user may require more than one template and multiple different data objects in a single documentation, multi-output, multi-label classification allows the model to predict the best combination of both. For example, for a given user profile (defined by factors such as, e.g., industry, company size, region, etc.) the model can predict that templates such Template1 and Template3 (from documentation metadata data structures 207) are relevant, while the necessary data objects might include sales revenue and hardware support. Such an approach can ensure that the generated documentation is tailored specifically to the user’s needs and/or preferences, helping to automate the documentation generation process while maintaining high accuracy and relevance.

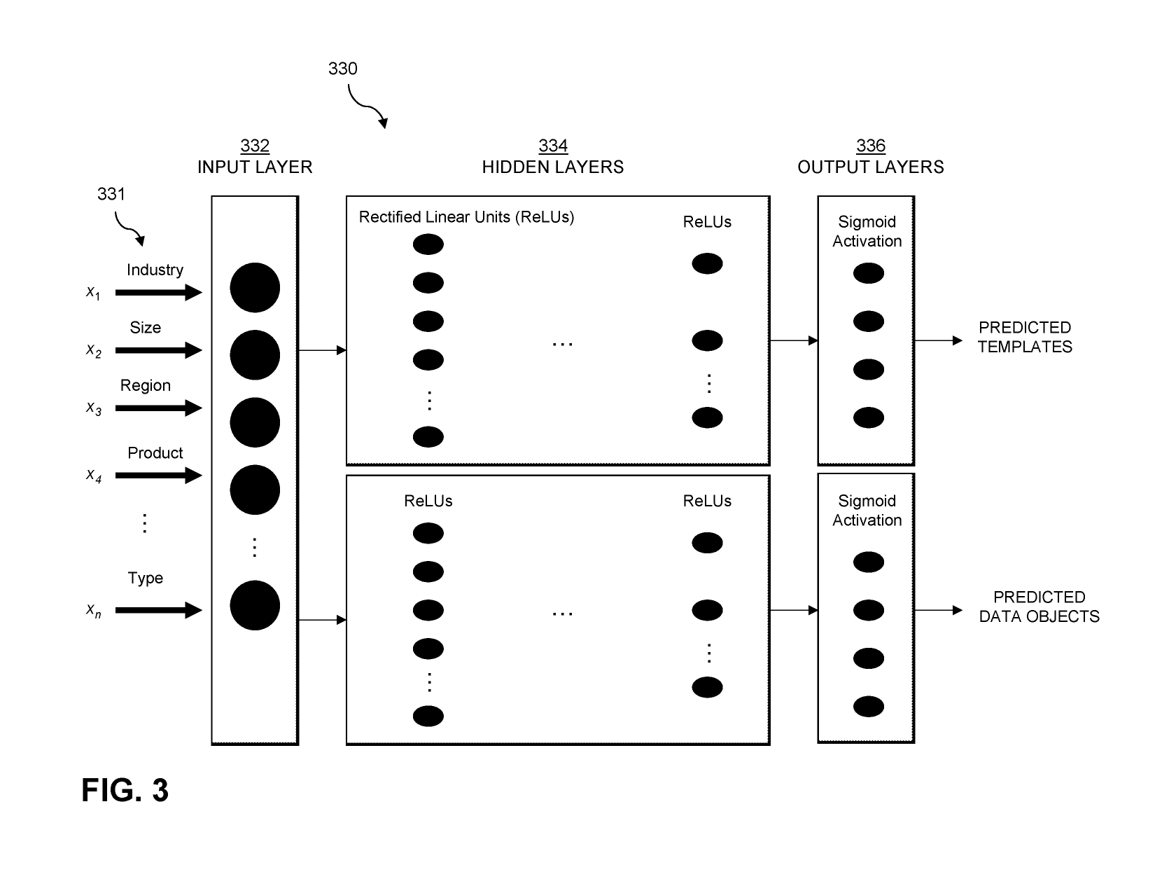

FIG. 3 shows example neural network architecture in an illustrative embodiment. By way of illustration, FIG. 3 depicts example architecture of a DNN-based multi-output, multi-label neural network 330 implemented (e.g., as part of document customization recommendation engine 114 and/or 214) to predict both templates and data objects. Such neural network architecture, supporting multi-output, multi-label classification, is designed to handle multiple target variables and predict multiple possible labels simultaneously.

More particularly, neural network 330 represents a feed-forward neural network with one or more hidden layers 334 and sigmoid activation functions in the one or more output layers 336. The input layer 332 accepts and/or processes input data 331 including features representing at least one user profile associated with the documentation request, wherein such features include industry (x ₁), size (x ₂), region (x ₃), product (x ₄), ... , and type (x n). Hidden layers 334, composed of neurons with activation functions including rectified linear unit (ReLU), capture patterns and interactions in the input data. The output layers 336 include multiple nodes, one node for each label (e.g., documentation templates and data objects), and use a sigmoid activation function to output probabilities for each label, indicating the likelihood of each template and/or data object being required in the user-requested documentation. The neural network 330 can be trained using binary cross-entropy loss, which evaluates the error for each label independently. This architecture allows the neural network 330 to handle the simultaneous prediction of multiple templates and data objects, efficiently supporting the generation of user-specific documentation.

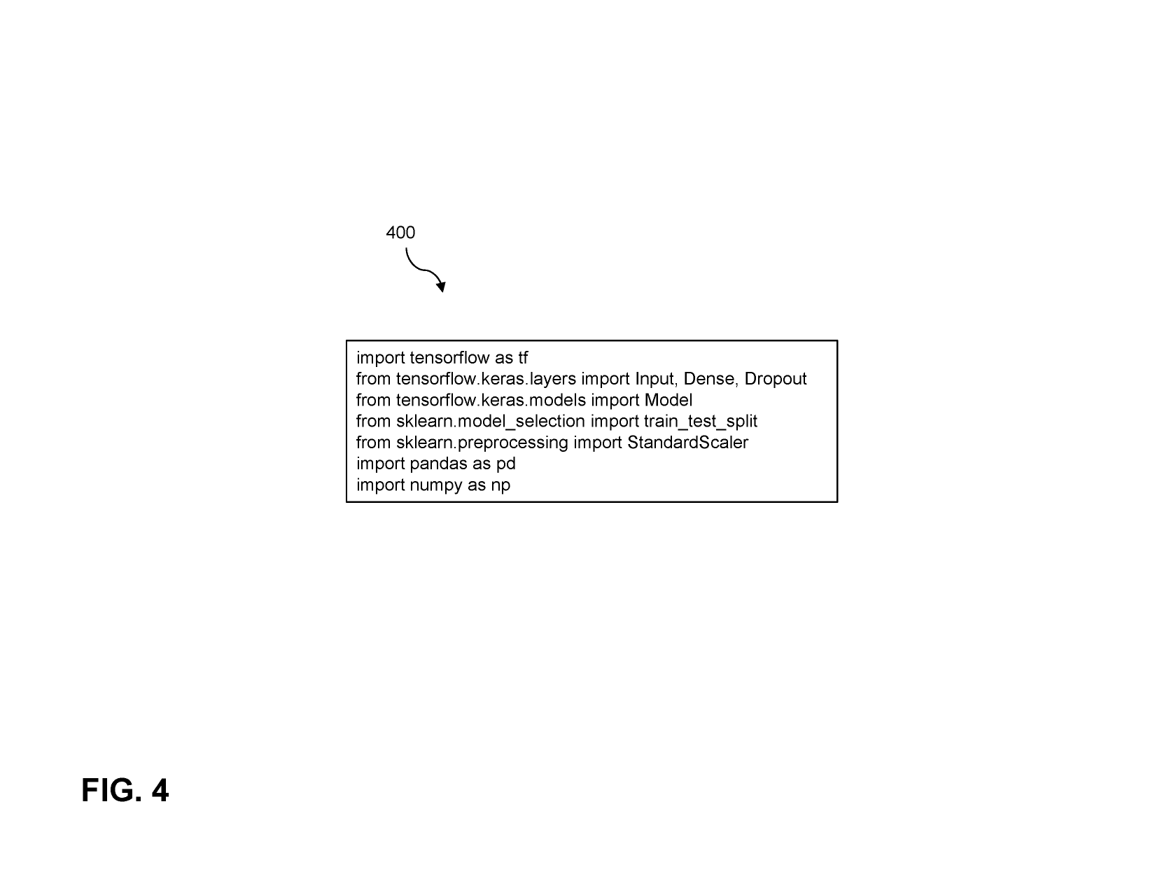

The implementation of artificial intelligence-based documentation generation system (e.g., system 105 in FIG. 1 and/or system 205 in FIG. 2) can be achieved, as implemented in the example pseudocode depicted in FIG. 4 through FIG. 16, using Keras with Tensorflow backend, Python language, as well as Pandas, Numpy and ScikitLearn libraries.

FIG. 4 shows example pseudocode for data preprocessing in an illustrative embodiment. In this embodiment, example pseudocode 400 is executed by or under the control of at least one processing system and/or device. For example, the example pseudocode 400 may be viewed as comprising a portion of a software implementation of at least part of artificial intelligence-based documentation generation system 105 of the FIG. 1 embodiment.

The example pseudocode 400 illustrates reading a dataset of historical documentation metadata and generating a Pandas data frame. The data frame can contain columns including independent variables and both dependent/target variable columns (i.e., documentation template and data objects). Additionally, in one or more embodiments, data preprocessing can also include handling any null or missing values in the columns. For example, null or missing values in numerical columns can be replaced by the median value of that column. After performing initial data analysis by creating one or more univariate plots and/or one or more bivariate plots of the columns, at least one embodiment can include determining the importance and/or influence of each column. Columns that have no role or influence on the actual prediction (i.e., the target variable) can be dropped and/or removed.

It is to be appreciated that this particular example pseudocode shows just one example implementation of data preprocessing, and alternative implementations can be used in other embodiments.

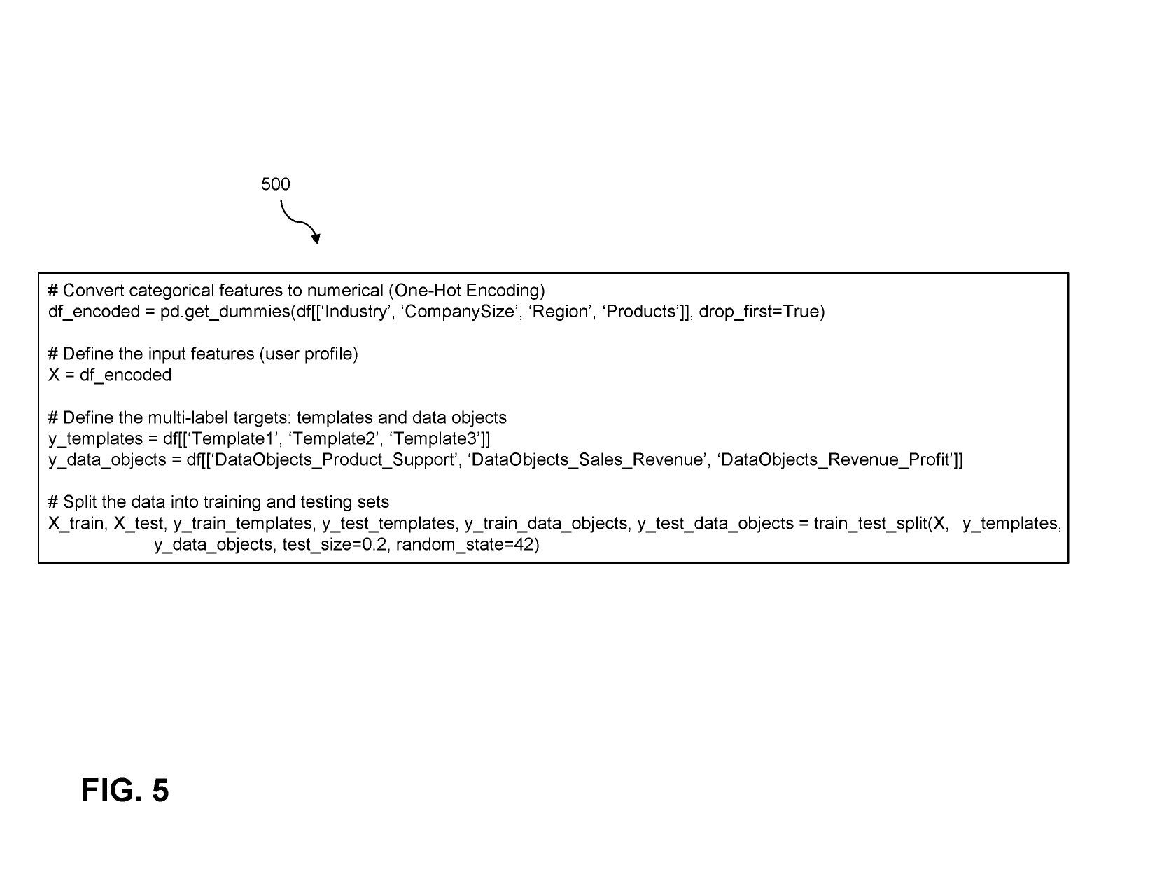

FIG. 5 shows example pseudocode for encoding categorical features and splitting data in an illustrative embodiment. In this embodiment, example pseudocode 500 is executed by or under the control of at least one processing system and/or device. For example, the example pseudocode 500 may be viewed as comprising a portion of a software implementation of at least part of artificial intelligence-based documentation generation system 105 of the FIG. 1 embodiment.

The example pseudocode 500 illustrates encoding textual categorical values in columns into numerical values, such that the values can be processed by the machine learning techniques. By way of example, at least one embodiment includes performing one-hot encoding of the categorical values. Also, example pseudocode 500 illustrates separating feature columns from target columns (e.g., two target columns) and initiating a data separation process. Further, the dataset is split into training and testing datasets using a train_test_split function of a ScikitLearn library (e.g., with an 80%-20% training-testing split). Additionally, because one or more embodiments include implementation in a use case of multi-target prediction, it is important to separate both of the target variables from the dataset.

It is to be appreciated that this particular example pseudocode shows just one example implementation of encoding categorical features and splitting data, and alternative implementations can be used in other embodiments.

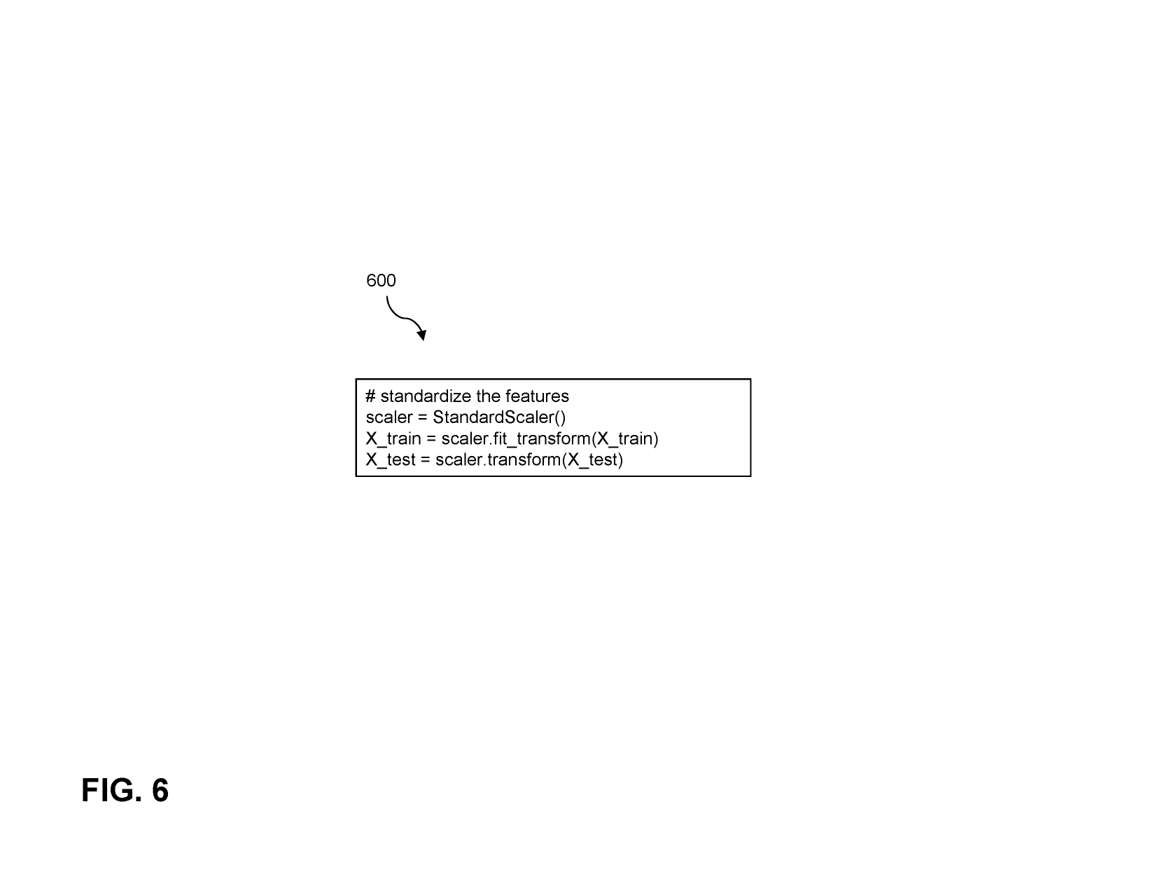

FIG. 6 shows example pseudocode for standardizing feature data in an illustrative embodiment. In this embodiment, example pseudocode 600 is executed by or under the control of at least one processing system and/or device. For example, the example pseudocode 600 may be viewed as comprising a portion of a software implementation of at least part of artificial intelligence-based documentation generation system 105 of the FIG. 1 embodiment.

The example pseudocode 600 illustrates scaling and normalizing the numerical features to improve the accuracy and performance of the model training.

It is to be appreciated that this particular example pseudocode shows just one example implementation of standardizing feature data, and alternative implementations can be used in other embodiments.

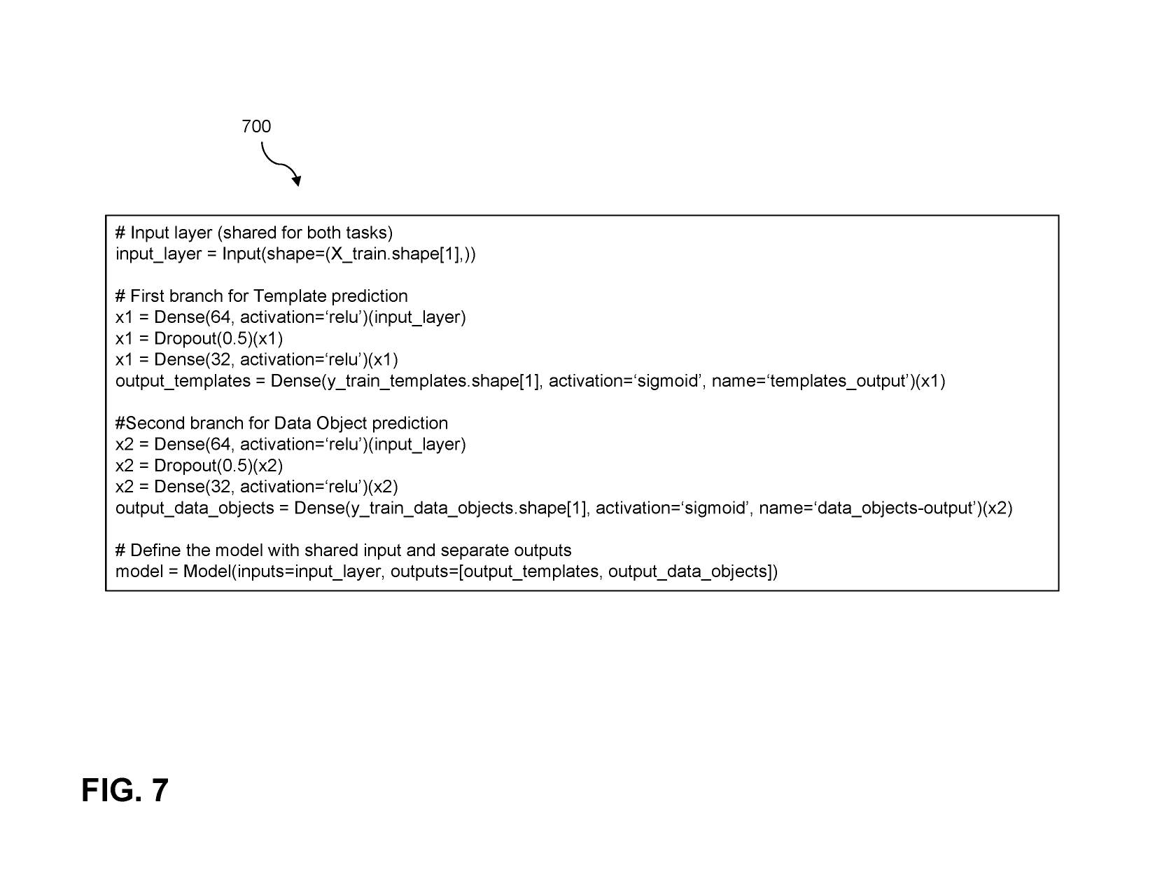

FIG. 7 shows example pseudocode for configuring a neural network model in an illustrative embodiment. In this embodiment, example pseudocode 700 is executed by or under the control of at least one processing system and/or device. For example, the example pseudocode 700 may be viewed as comprising a portion of a software implementation of at least part of artificial intelligence-based documentation generation system 105 of the FIG. 1 embodiment.

The example pseudocode 700 illustrates creating a multi-layer, multi-output and multi-label classification-capable dense neural network using a Keras library. As depicted in FIG. 4, the neural network is configured using a Keras sequential function. More particularly, two separate branches of the neural network are added to an input layer with ReLU as the activation function. Also, an output layer is then added with four neurons (for four type classes) with a sigmoid activation function added to each layer.

It is to be appreciated that this particular example pseudocode shows just one example implementation of configuring a neural network model, and alternative implementations can be used in other embodiments.

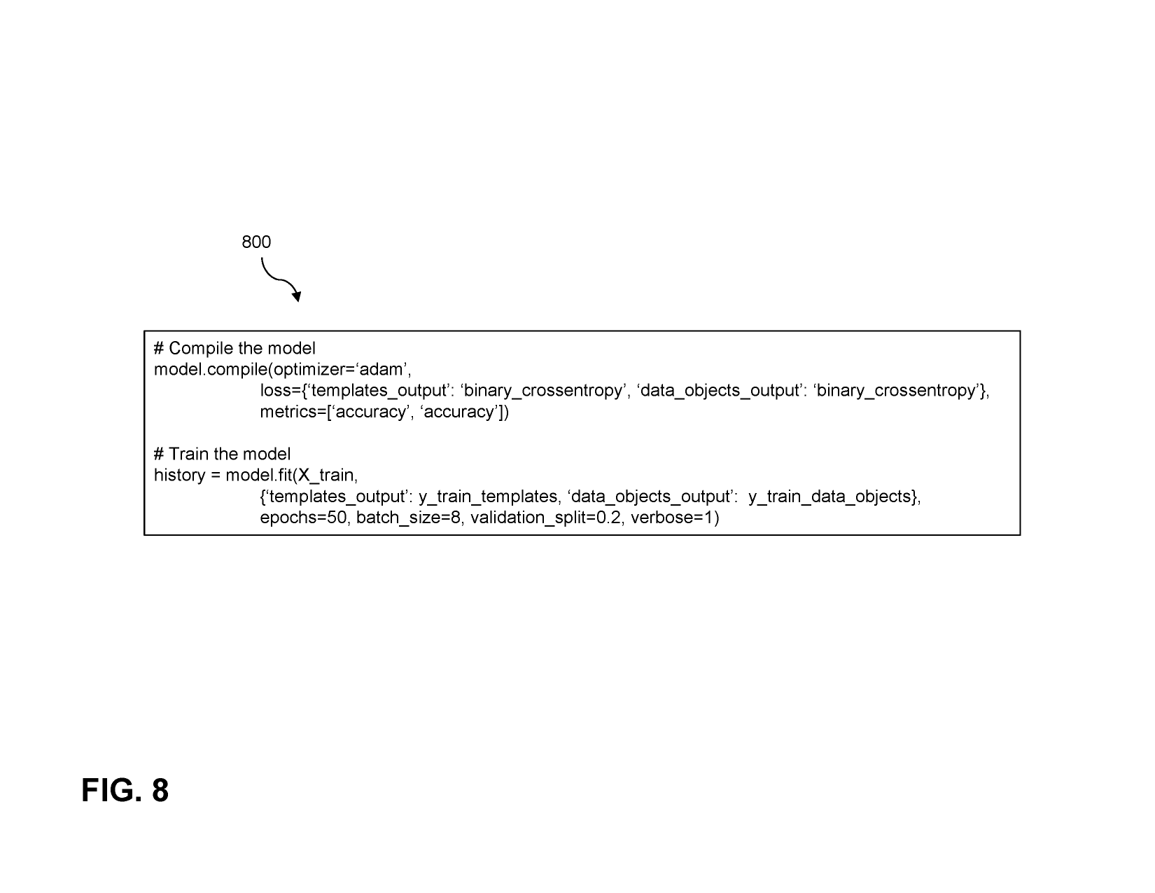

FIG. 8 shows example pseudocode for compiling and training the neural network model in an illustrative embodiment. In this embodiment, example pseudocode 800 is executed by or under the control of at least one processing system and/or device. For example, the example pseudocode 800 may be viewed as comprising a portion of a software implementation of at least part of artificial intelligence-based documentation generation system 105 of the FIG. 1 embodiment.

The example pseudocode 800 illustrates using an adaptive moment estimation (Adam) optimizer, binary_cross_entropy as the loss function, and accuracy as the metric for the network. Also, the neural network model is trained with the independent variables training data (X_train) and the target variables are passed for each path.

It is to be appreciated that this particular example pseudocode shows just one example implementation of compiling and training the neural network model, and alternative implementations can be used in other embodiments.

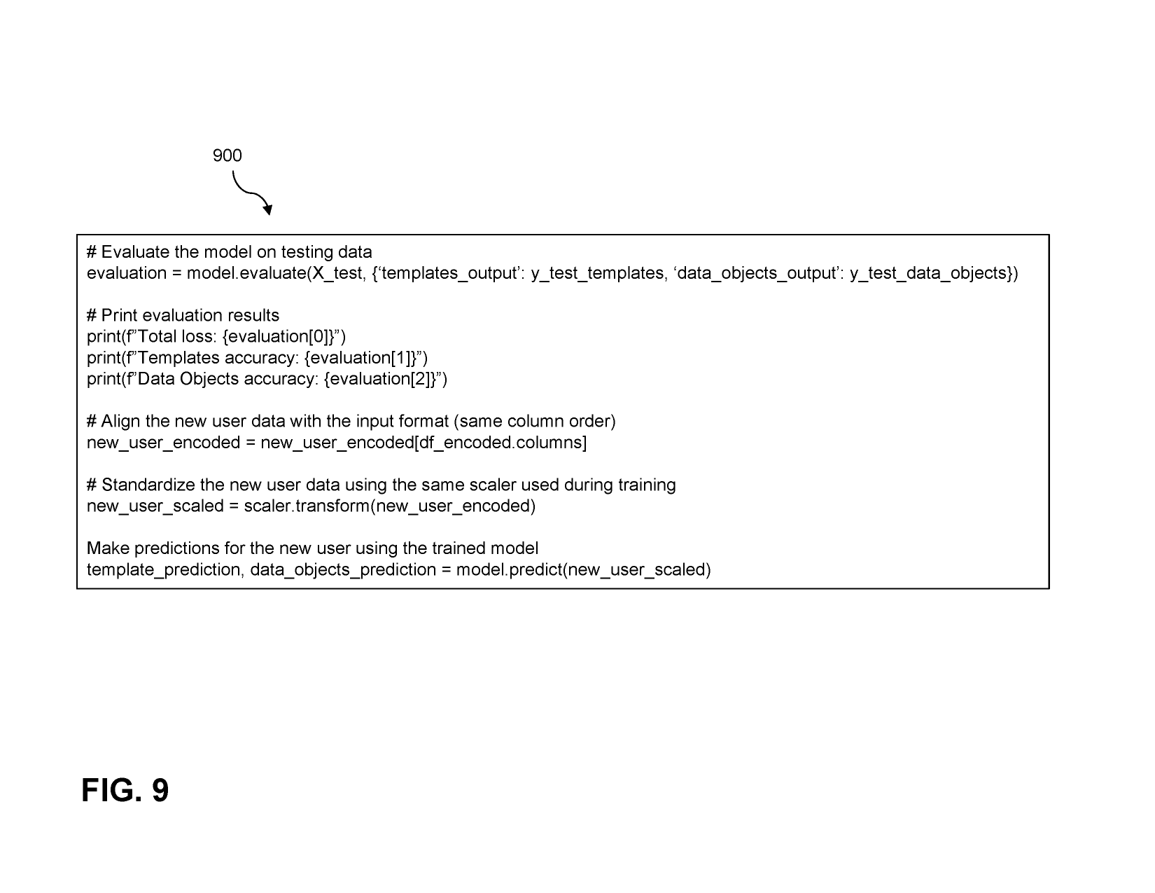

FIG. 9 shows example pseudocode for evaluating and implementing the neural network model in an illustrative embodiment. In this embodiment, example pseudocode 900 is executed by or under the control of at least one processing system and/or device. For example, the example pseudocode 900 may be viewed as comprising a portion of a software implementation of at least part of artificial intelligence-based documentation generation system 105 of the FIG. 1 embodiment.

The example pseudocode 900 illustrates evaluating the neural network model using testing data, and printing the evaluation results. Also, example pseudocode 900 illustrates aligning new user data with input format, standardizing the new user data using at least one scaler from model training, and implementing the trained neural network model to predict both target values by passing independent variable values to the predict() function of the neural network model.

It is to be appreciated that this particular example pseudocode shows just one example implementation of evaluating and implementing the neural network model, and alternative implementations can be used in other embodiments.

Referring again to FIG. 2, one or more embodiments include implementing context-based documentation generation engine 216 to dynamically generate user-specific documentation using one or more recommended documentation templates and one or more corresponding recommended data objects. In such an embodiment, context-based documentation generation engine 216 can include implementing a RAG architecture-based GenAI technique to dynamically generate the documentation by filling in the template sections with the provided data. The templates contain placeholders for each section and identification of the corresponding data elements. The templates can serve as a guide for the GenAI on how to structure and generate the documentation.

Such an embodiment includes retrieving user-specific data for each of one or more data objects from respective data sources. This data will be retrieved as part of a retrieval step of the RAG architecture and passed with the prompt to at least one LLM for generating the documentation. The prompt that contains the documentation template and the data array will indicate that the LLM should use the provided data to fill in the sections of the documentation. Next the LLM generates the documentation by inserting the data into the appropriate sections based on the template, and one or more additional instructions (e.g., summarize the report, provide improvements, etc.) can be provided in the prompt as well.

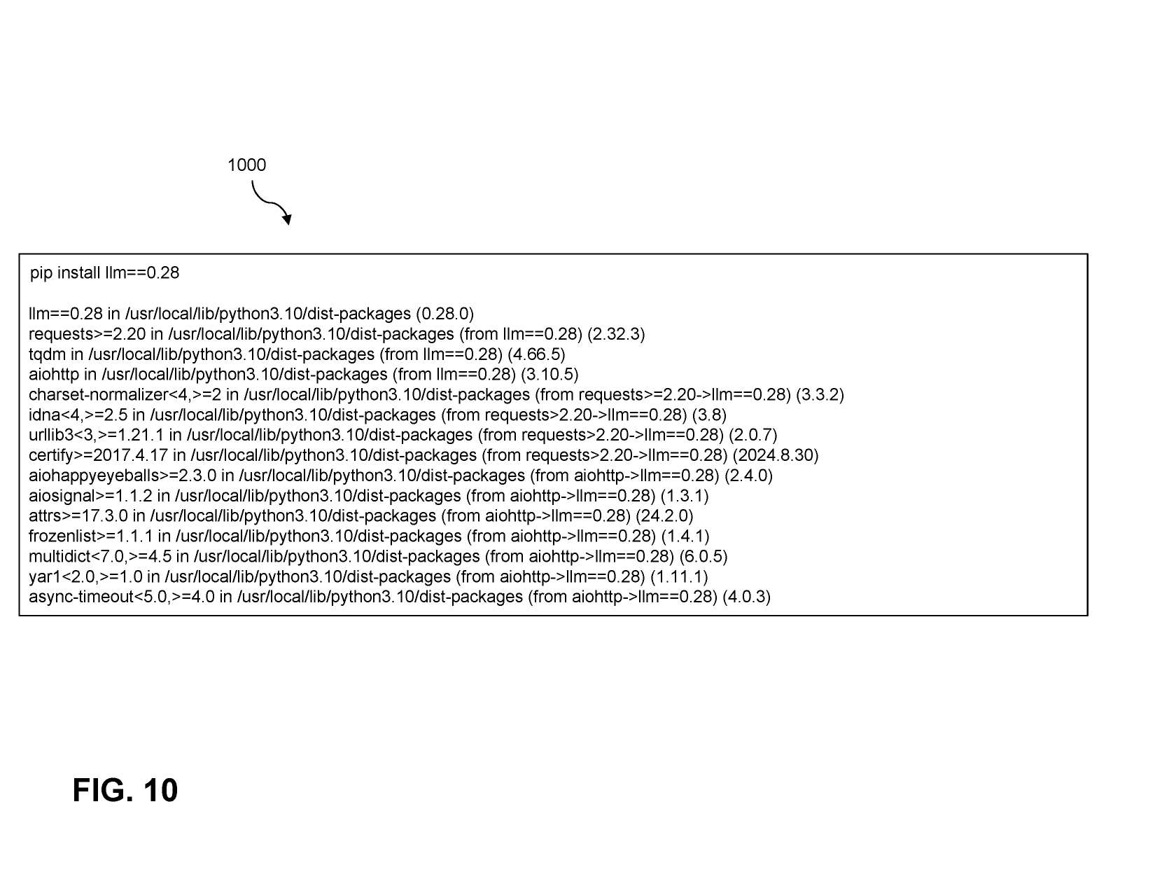

In one or more embodiments, the context-based documentation generation engine can be implemented as detailed below in connection with FIG. 10 through FIG. 16, leveraging a sample template for product support documentation for a user, sample support data retrieved for the user and an LLM to generate the documentation and additional insights on improvements.

FIG. 10 shows example pseudocode for installing an LLM library in an illustrative embodiment. In this embodiment, example pseudocode 1000 is executed by or under the control of at least one processing system and/or device. For example, the example pseudocode 1000 may be viewed as comprising a portion of a software implementation of at least part of artificial intelligence-based documentation generation system 105 of the FIG. 1 embodiment.

The example pseudocode 1000 illustrates installing an LLM library so that the functions can subsequently be used to call the LLM.

It is to be appreciated that this particular example pseudocode shows just one example implementation of installing an LLM library, and alternative implementations can be used in other embodiments.

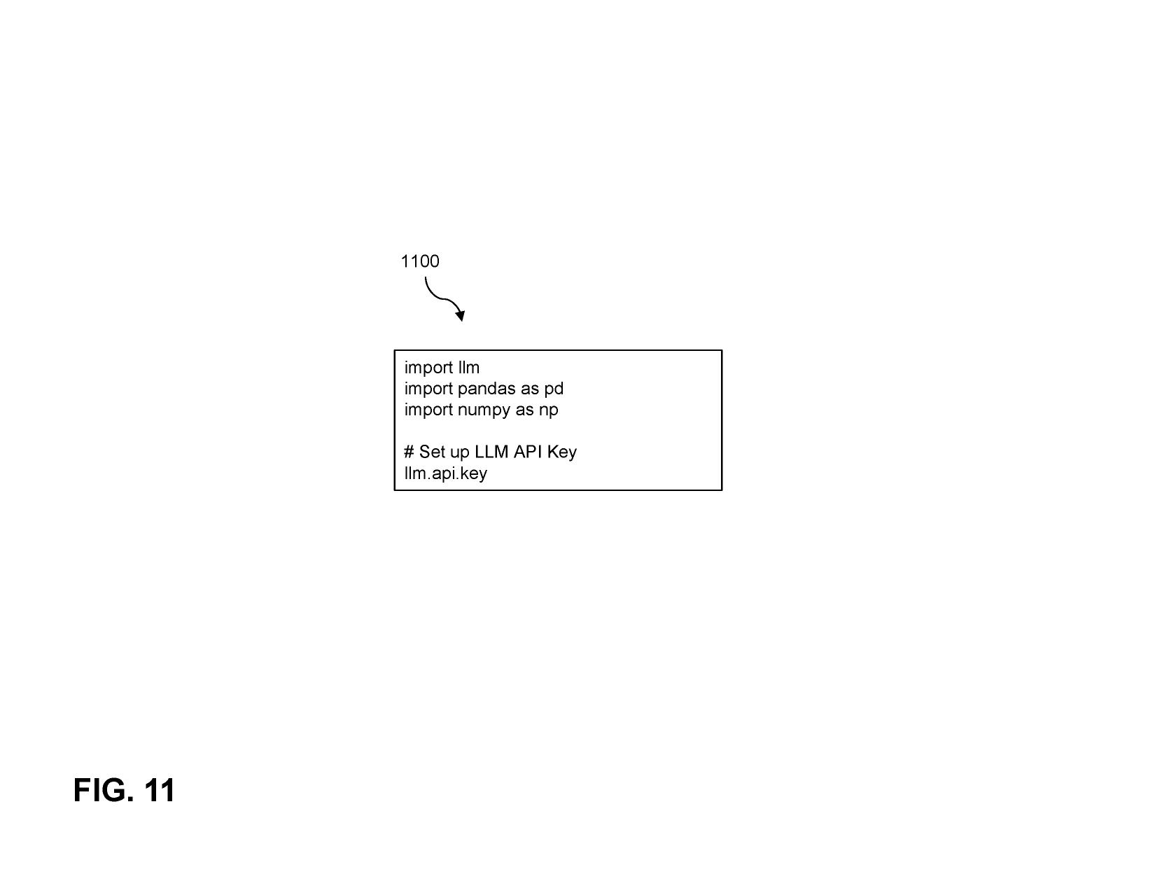

FIG. 11 shows example pseudocode for importing an LLM and API key value in an illustrative embodiment. In this embodiment, example pseudocode 1100 is executed by or under the control of at least one processing system and/or device. For example, the example pseudocode 1100 may be viewed as comprising a portion of a software implementation of at least part of artificial intelligence-based documentation generation system 105 of the FIG. 1 embodiment.

The example pseudocode 1100 illustrates importing the necessary LLM libraries along with providing the LLM key value.

It is to be appreciated that this particular example pseudocode shows just one example implementation of importing an LLM and API key value, and alternative implementations can be used in other embodiments.

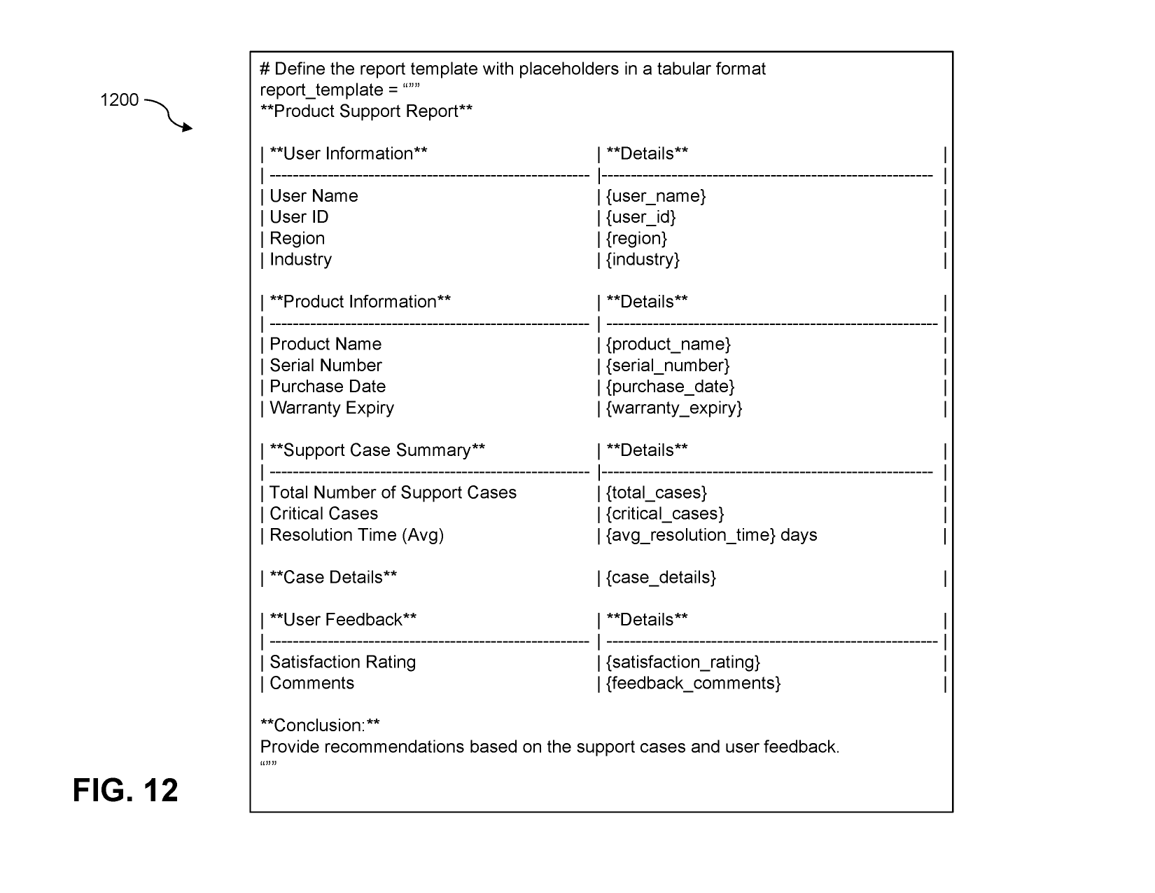

FIG. 12 shows example pseudocode for defining the documentation template in a tabular format in an illustrative embodiment. In this embodiment, example pseudocode 1200 is executed by or under the control of at least one processing system and/or device. For example, the example pseudocode 1200 may be viewed as comprising a portion of a software implementation of at least part of artificial intelligence-based documentation generation system 105 of the FIG. 1 embodiment.

The example pseudocode 1200 illustrates creating a sample documentation template with the associated data structure, and providing additional instructions on the documentation for generating insights.

It is to be appreciated that this particular example pseudocode shows just one example implementation of defining the documentation template in a tabular format, and alternative implementations can be used in other embodiments.

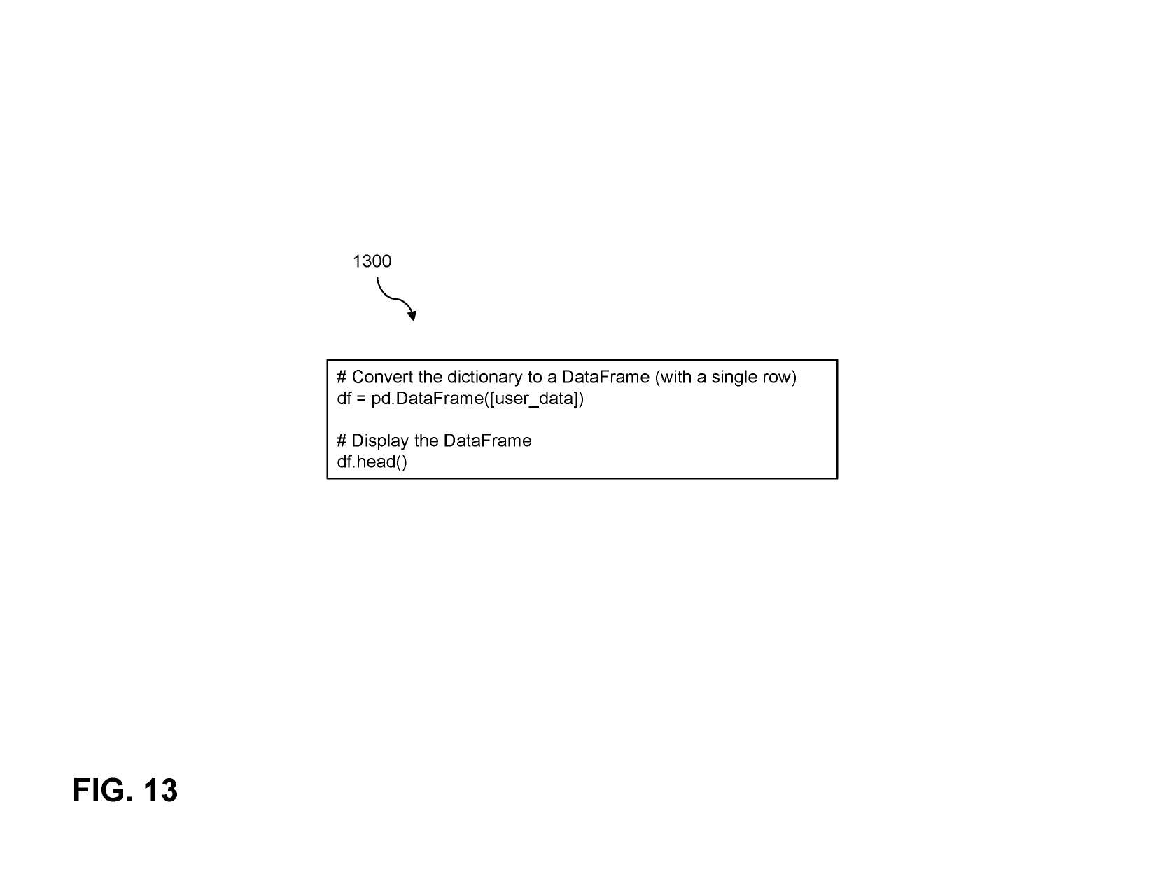

FIG. 13 shows example pseudocode for converting the LLM dictionary to a data frame in an illustrative embodiment. In this embodiment, example pseudocode 1300 is executed by or under the control of at least one processing system and/or device. For example, the example pseudocode 1300 may be viewed as comprising a portion of a software implementation of at least part of artificial intelligence-based documentation generation system 105 of the FIG. 1 embodiment.

The example pseudocode 1300 illustrates creating and printing a Pandas data frame once user-specific data is retrieved from a database.

It is to be appreciated that this particular example pseudocode shows just one example implementation of converting the LLM dictionary to a data frame, and alternative implementations can be used in other embodiments.

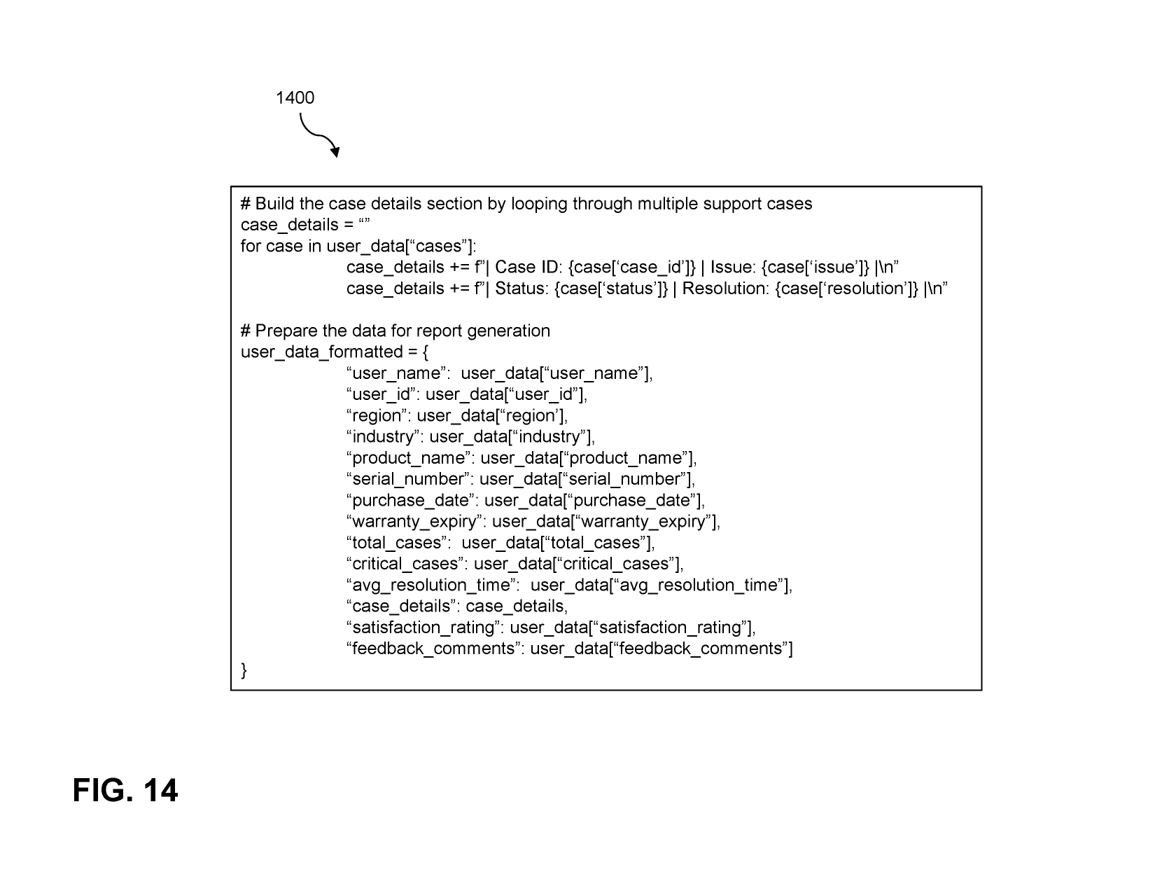

FIG. 14 shows example pseudocode for building case details sections of documentation in an illustrative embodiment. In this embodiment, example pseudocode 1400 is executed by or under the control of at least one processing system and/or device. For example, the example pseudocode 1400 may be viewed as comprising a portion of a software implementation of at least part of artificial intelligence-based documentation generation system 105 of the FIG. 1 embodiment.

The example pseudocode 1400 illustrates iterating through multiple cases to build the case detail section of the documentation such that formatted user data is created.

It is to be appreciated that this particular example pseudocode shows just one example implementation of building case details sections of documentation, and alternative implementations can be used in other embodiments.

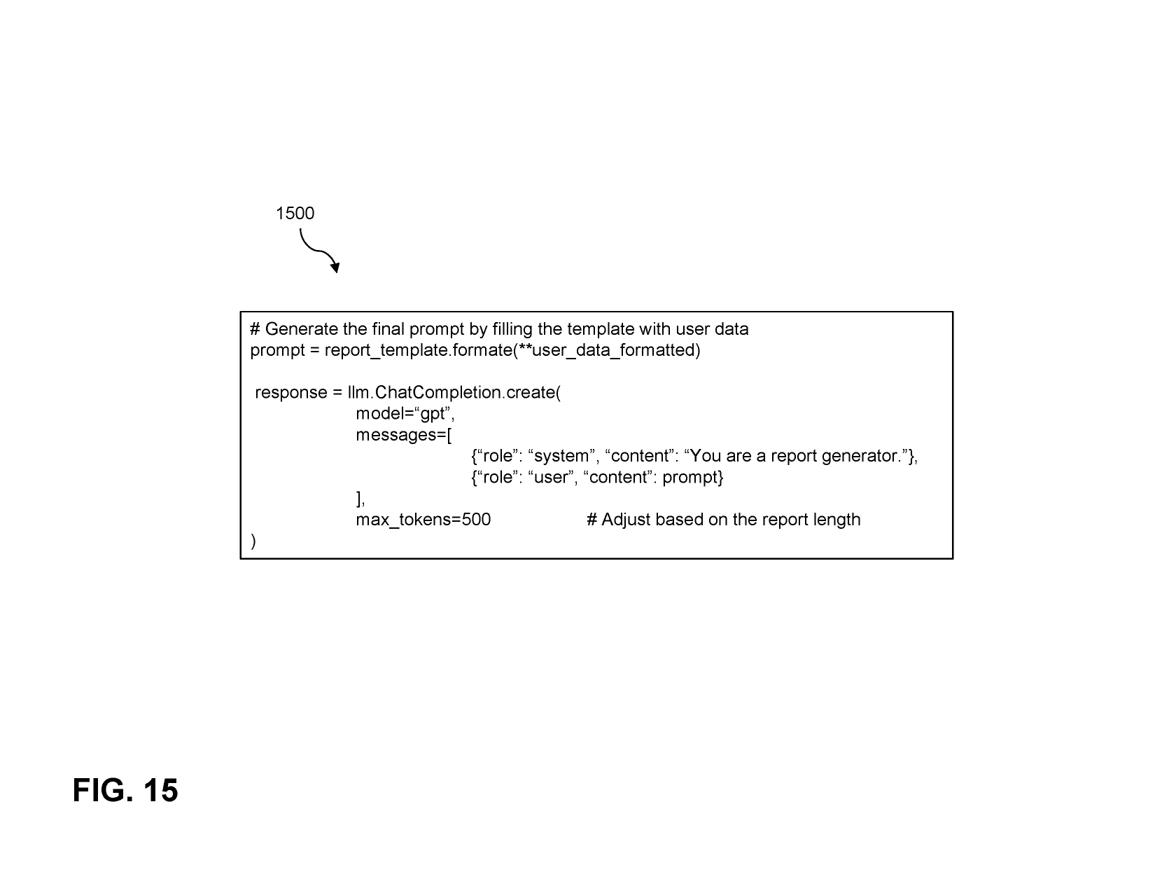

FIG. 15 shows example pseudocode for generating an LLM prompt in an illustrative embodiment. In this embodiment, example pseudocode 1500 is executed by or under the control of at least one processing system and/or device. For example, the example pseudocode 1500 may be viewed as comprising a portion of a software implementation of at least part of artificial intelligence-based documentation generation system 105 of the FIG. 1 embodiment.

The example pseudocode 1500 illustrates building a prompt for the LLM by filling in the template(s) with user-related data, and sending the prompt to the LLM for a response.

It is to be appreciated that this particular example pseudocode shows just one example implementation of generating an LLM prompt, and alternative implementations can be used in other embodiments.

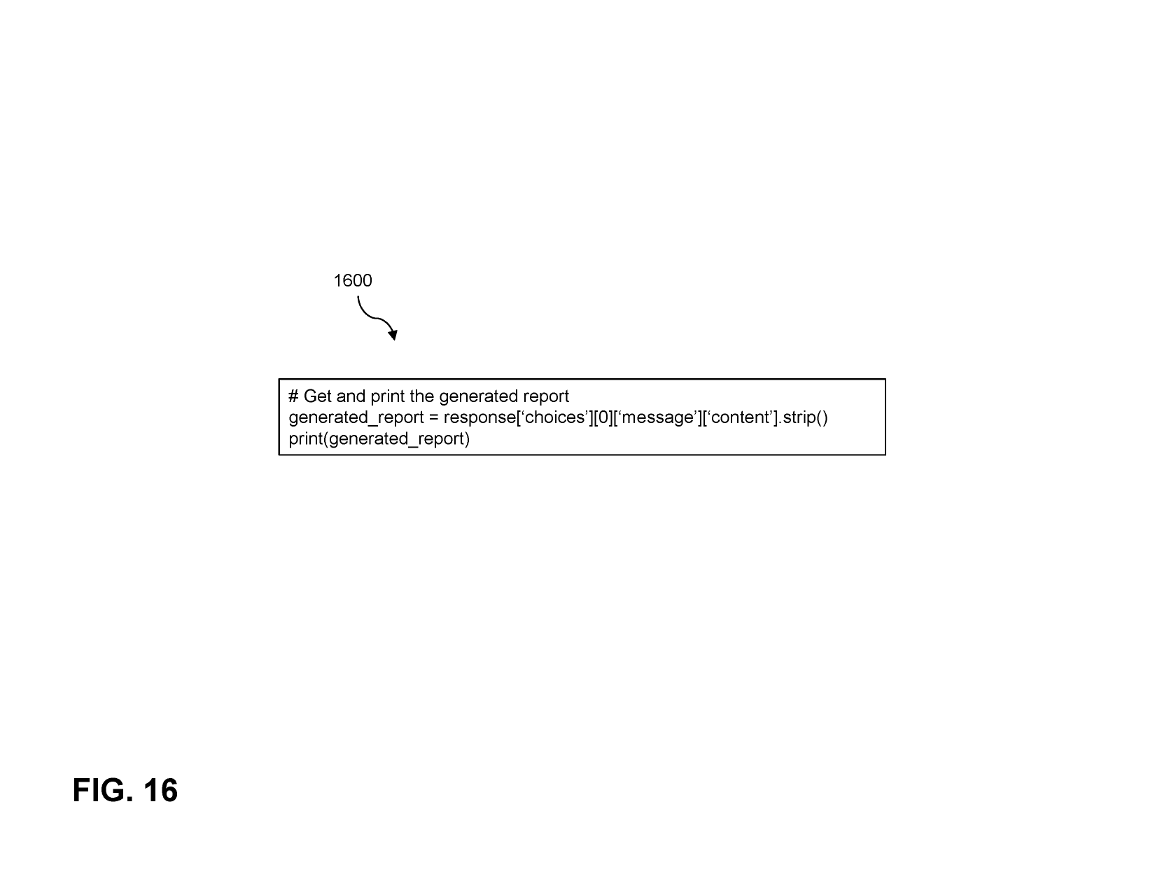

FIG. 16 shows example pseudocode for generating and printing the documentation in an illustrative embodiment. In this embodiment, example pseudocode 1600 is executed by or under the control of at least one processing system and/or device. For example, the example pseudocode 1600 may be viewed as comprising a portion of a software implementation of at least part of artificial intelligence-based documentation generation system 105 of the FIG. 1 embodiment.

The example pseudocode 1600 illustrates extracting the documentation from the response and printing at least portions of the documentation.

It is to be appreciated that this particular example pseudocode shows just one example implementation of generating and printing the documentation, and alternative implementations can be used in other embodiments.

FIG. 17 is a flow diagram of a process for automatically generating context-based system-related documentation using artificial intelligence techniques in an illustrative embodiment. It is to be understood that this particular process is only an example, and additional or alternative processes can be carried out in other embodiments.

In this embodiment, the process includes steps 1700 through 1708. These steps are assumed to be performed by the artificial intelligence-based documentation generation system 105 utilizing elements 112, 114 and 116.

Step 1700 includes obtaining at least one system-related documentation generation request. In at least one embodiment, obtaining the at least one system-related documentation generation request includes validating at least one entitlement of at least one user device associated with the at least one system-related documentation generation request.

Step 1702 includes identifying one or more context-based features of the at least one system-related documentation generation request. In one or more embodiments, identifying one or more context-based features of the at least one system-related documentation generation request includes identifying one or more features pertaining to one or more users associated with the at least one system-related documentation generation request and identifying one or more features pertaining to one or more system-related elements associated with the at least one system-related documentation generation request.

Step 1704 includes determining one or more documentation templates, and one or more data objects corresponding thereto, to be used in connection with documentation generation by processing, using a first set of one or more artificial intelligence techniques, at least a portion of the at least one system-related documentation generation request and at least a portion of the one or more context-based features. In at least one embodiment, determining one or more documentation templates and one or more data objects corresponding thereto includes processing the at least a portion of the at least one system-related documentation generation request and the at least a portion of the one or more context-based features using at least one DNN-based multi-target classifier. Additionally or alternatively, determining one or more documentation templates and one or more data objects corresponding thereto can include identifying, by processing at least a portion of one or more documentation metadata data structures, one or more items of historical documentation associated with one or more requests sharing a designated level of similarity with the at least one system-related documentation generation request.

Step 1706 includes generating documentation in response to the at least one system-related documentation generation request by using at least a portion of the one or more documentation templates and at least a portion of the one or more data objects corresponding thereto in conjunction with a second set of one or more artificial intelligence techniques. In one or more embodiments, generating documentation includes leveraging one or more GenAI techniques and one or more RAG techniques. In such an embodiment, generating documentation can include retrieving from one or more data sources and using at least a portion of the one or more RAG techniques, the at least a portion of the one or more documentation templates and data pertaining to the at least a portion of the one or more data objects, and providing the retrieved portion of the one or more documentation templates and the retrieved data to at least one LLM associated with at least a portion of the one or more GenAI techniques. Further, in such an embodiment, generating documentation can include inserting, using the at least one LLM, the retrieved data into one or more designated sections of the retrieved portion of the one or more documentation templates.

Step 1708 includes performing one or more automated actions based at least in part on the generated documentation. In at least one embodiment, performing one or more automated actions includes automatically outputting the generated documentation to one or more user devices associated with the at least one system-related documentation generation request. Additionally or alternatively, performing one or more automated actions can include automatically training, using one or more portions of the generated documentation, one or more of at least a portion of the first set of one or more artificial intelligence techniques and at least a portion of the second set of one or more artificial intelligence techniques.

Accordingly, the particular processing operations and other functionality described in conjunction with the flow diagram of FIG. 17 are presented by way of illustrative example only, and should not be construed as limiting the scope of the disclosure in any way. For example, the ordering of the process steps may be varied in other embodiments, or certain steps may be performed concurrently with one another rather than serially.

The above-described illustrative embodiments provide significant advantages relative to conventional approaches. For example, some embodiments are configured to automatically recommend templates and corresponding data objects for use in automated documentation generation using artificial intelligence techniques. These and other embodiments can effectively overcome problems associated with errors and latencies arising from resource-intensive conventional methods.

It is to be appreciated that the particular advantages described above and elsewhere herein are associated with particular illustrative embodiments and need not be present in other embodiments. Also, the particular types of information processing system features and functionality as illustrated in the drawings and described above are exemplary only, and numerous other arrangements may be used in other embodiments.

As mentioned previously, at least portions of the information processing system 100 can be implemented using one or more processing platforms. A given processing platform comprises at least one processing device comprising a processor coupled to a memory. The processor and memory in some embodiments comprise respective processor and memory elements of a virtual machine or container provided using one or more underlying physical machines. The term “processing device” as used herein is intended to be broadly construed so as to encompass a wide variety of different arrangements of physical processors, memories and other device components as well as virtual instances of such components. For example, a “processing device” in some embodiments can comprise or be executed across one or more virtual processors. Processing devices can therefore be physical or virtual and can be executed across one or more physical or virtual processors. It should also be noted that a given virtual device can be mapped to a portion of a physical one.

Some illustrative embodiments of a processing platform used to implement at least a portion of an information processing system comprises cloud infrastructure including virtual machines implemented using a hypervisor that runs on physical infrastructure. The cloud infrastructure further comprises sets of applications running on respective ones of the virtual machines under the control of the hypervisor. It is also possible to use multiple hypervisors each providing a set of virtual machines using at least one underlying physical machine. Different sets of virtual machines provided by one or more hypervisors may be utilized in configuring multiple instances of various components of the system.

These and other types of cloud infrastructure can be used to provide what is also referred to herein as a multi-tenant environment. One or more system components, or portions thereof, are illustratively implemented for use by tenants of such a multi-tenant environment.

As mentioned previously, cloud infrastructure as disclosed herein can include cloud-based systems. Virtual machines provided in such systems can be used to implement at least portions of a computer system in illustrative embodiments.

In some embodiments, the cloud infrastructure additionally or alternatively comprises a plurality of containers implemented using container host devices. For example, as detailed herein, a given container of cloud infrastructure illustratively comprises a Docker container or other type of Linux Container (LXC). The containers are run on virtual machines in a multi-tenant environment, although other arrangements are possible. The containers are utilized to implement a variety of different types of functionality within the system 100. For example, containers can be used to implement respective processing devices providing compute and/or storage services of a cloud-based system. Again, containers may be used in combination with other virtualization infrastructure such as virtual machines implemented using a hypervisor.

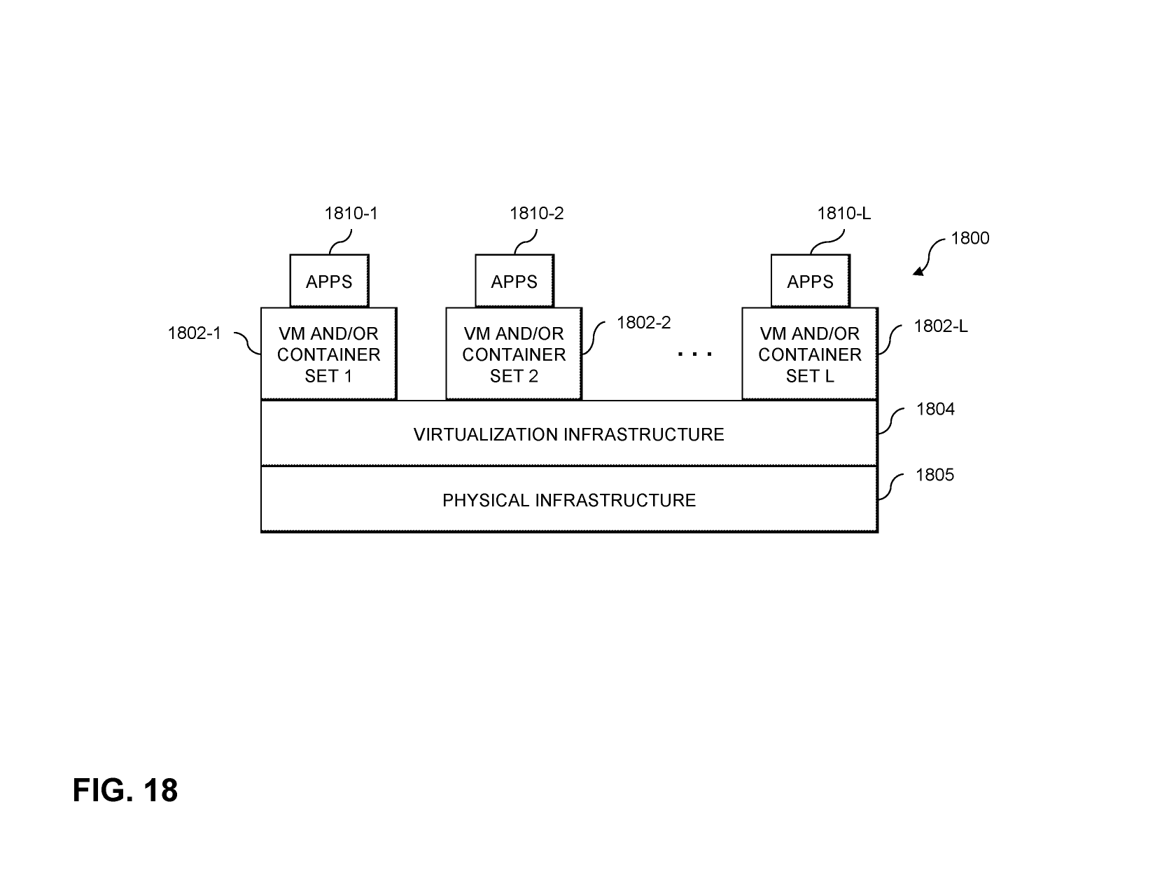

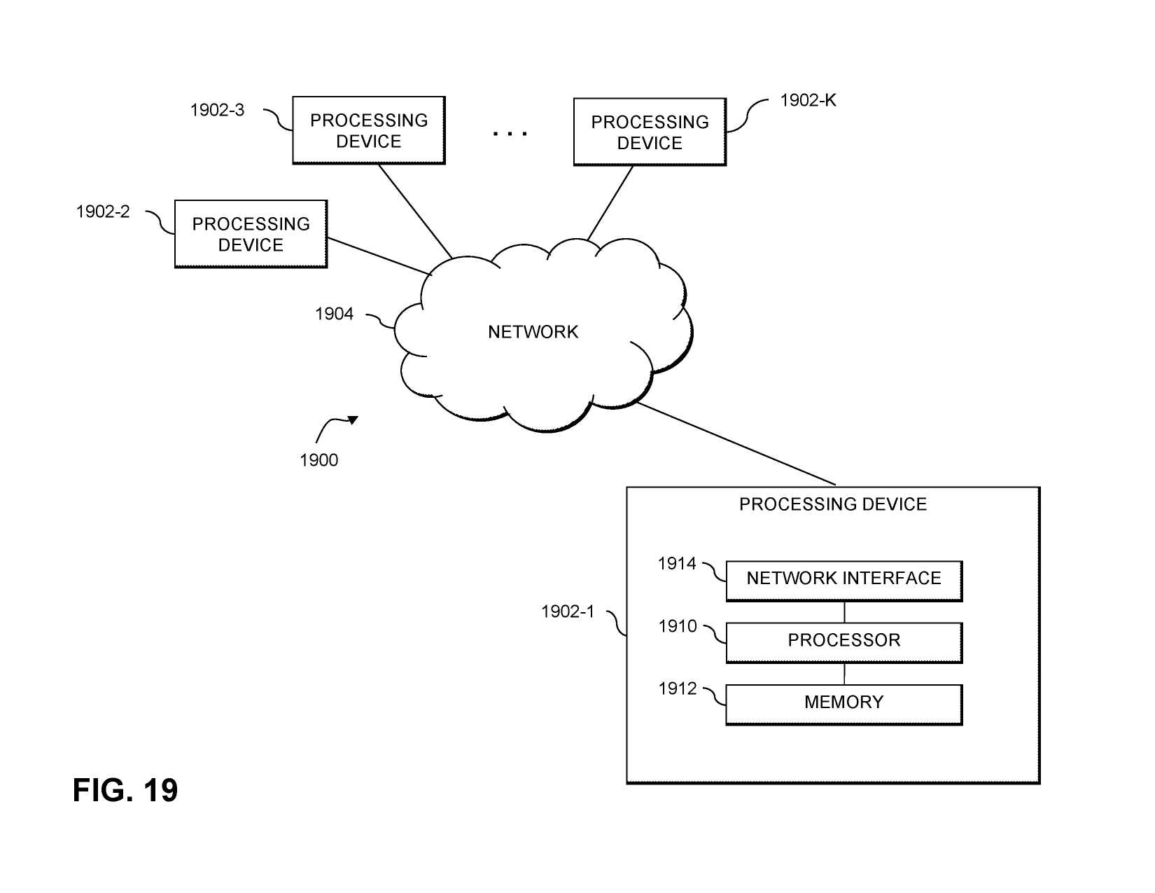

Illustrative embodiments of processing platforms will now be described in greater detail with reference to FIGS. 18 and 19. Although described in the context of system 100, these platforms may also be used to implement at least portions of other information processing systems in other embodiments.

FIG. 18 shows an example processing platform comprising cloud infrastructure 1800. The cloud infrastructure 1800 comprises a combination of physical and virtual processing resources that are utilized to implement at least a portion of the information processing system 100. The cloud infrastructure 1800 comprises multiple virtual machines (VMs) and/or container sets 1802-1, 1802-2, . . . 1802-L implemented using virtualization infrastructure 1804. The virtualization infrastructure 1804 runs on physical infrastructure 1805, and illustratively comprises one or more hypervisors and/or operating system level virtualization infrastructure. The operating system level virtualization infrastructure illustratively comprises kernel control groups of a Linux operating system or other type of operating system.

The cloud infrastructure 1800 further comprises sets of applications 1810-1, 1810-2, . . . 1810-L running on respective ones of the VMs/container sets 1802-1, 1802-2, . . . 1802-L under the control of the virtualization infrastructure 1804. The VMs/container sets 1802 comprise respective VMs, respective sets of one or more containers, or respective sets of one or more containers running in VMs. In some implementations of the FIG. 18 embodiment, the VMs/container sets 1802 comprise respective VMs implemented using virtualization infrastructure 1804 that comprises at least one hypervisor.

A hypervisor platform may be used to implement a hypervisor within the virtualization infrastructure 1804, wherein the hypervisor platform has an associated virtual infrastructure management system. The underlying physical machines comprise one or more information processing platforms that include one or more storage systems.

In other implementations of the FIG. 18 embodiment, the VMs/container sets 1802 comprise respective containers implemented using virtualization infrastructure 1804 that provides operating system level virtualization functionality, such as support for Docker containers running on bare metal hosts, or Docker containers running on VMs. The containers are illustratively implemented using respective kernel control groups of the operating system.

As is apparent from the above, one or more of the processing modules or other components of system 100 may each run on a computer, server, storage device or other processing platform element. A given such element is viewed as an example of what is more generally referred to herein as a “processing device.” The cloud infrastructure 1800 shown in FIG. 18 may represent at least a portion of one processing platform. Another example of such a processing platform is processing platform 1900 shown in FIG. 19.

The processing platform 1900 in this embodiment comprises a portion of system 100 and includes a plurality of processing devices, denoted 1902-1, 1902-2, 1902-3, . . . 1902-K, which communicate with one another over a network 1904.

The network 1904 comprises any type of network, including by way of example a global computer network such as the Internet, a WAN, a LAN, a satellite network, a telephone or cable network, a cellular network, a wireless network such as a Wi-Fi or WiMAX network, or various portions or combinations of these and other types of networks.

The processing device 1902-1 in the processing platform 1900 comprises a processor 1910 coupled to a memory 1912.

The processor 1910 comprises a microprocessor, an ASIC, an SOC, an FPGA, a CPU, a GPU, an NPU, a DPU, a TPU, an ALU, a DSP, and/or other similar processing device components, as well as other types and arrangements of processing circuitry, in any combination. At least a portion of the functionality of at least one artificial intelligence system and its associated artificial intelligence algorithms provided by one or more processing devices as disclosed herein can be implemented using such circuitry.

The memory 1912 comprises RAM, ROM or other types of memory, in any combination. The memory 1912 and other memories disclosed herein should be viewed as illustrative examples of what are more generally referred to as “processor-readable storage media” storing executable program code of one or more software programs.

Articles of manufacture comprising such processor-readable storage media are considered illustrative embodiments. A given such article of manufacture comprises, for example, a storage array, a storage disk or an integrated circuit containing RAM, ROM or other electronic memory, or any of a wide variety of other types of computer program products. The term “article of manufacture” as used herein should be understood to exclude transitory, propagating signals. Numerous other types of computer program products comprising processor-readable storage media can be used.

Also included in the processing device 1902-1 is network interface circuitry 1914, which is used to interface the processing device with the network 1904 and other system components, and may comprise conventional transceivers.

The other processing devices 1902 of the processing platform 1900 are assumed to be configured in a manner similar to that shown for processing device 1902-1 in the figure.

Again, the particular processing platform 1900 shown in the figure is presented by way of example only, and system 100 may include additional or alternative processing platforms, as well as numerous distinct processing platforms in any combination, with each such platform comprising one or more computers, servers, storage devices or other processing devices.

For example, other processing platforms used to implement illustrative embodiments can comprise different types of virtualization infrastructure, in place of or in addition to virtualization infrastructure comprising virtual machines. Such virtualization infrastructure illustratively includes container-based virtualization infrastructure configured to provide Docker containers or other types of LXCs.

As another example, portions of a given processing platform in some embodiments can comprise converged infrastructure.

It should therefore be understood that in other embodiments different arrangements of additional or alternative elements may be used. At least a subset of these elements may be collectively implemented on a common processing platform, or each such element may be implemented on a separate processing platform.

Also, numerous other arrangements of computers, servers, storage products or devices, or other components are possible in the information processing system 100. Such components can communicate with other elements of the information processing system 100 over any type of network or other communication media.

For example, particular types of storage products that can be used in implementing a given storage system of an information processing system in an illustrative embodiment include all-flash and hybrid flash storage arrays, scale-out all-flash storage arrays, scale-out NAS clusters, or other types of storage arrays. Combinations of multiple ones of these and other storage products can also be used in implementing a given storage system in an illustrative embodiment.

It should again be emphasized that the above-described embodiments are presented for purposes of illustration only. Many variations and other alternative embodiments may be used. Also, the particular configurations of system and device elements and associated processing operations illustratively shown in the drawings can be varied in other embodiments. Thus, for example, the particular types of processing devices, modules, systems and resources deployed in a given embodiment and their respective configurations may be varied. Moreover, the various assumptions made above in the course of describing the illustrative embodiments should also be viewed as exemplary rather than as requirements or limitations of the disclosure. Numerous other alternative embodiments within the scope of the appended claims will be readily apparent to those skilled in the art.

What is claimed is:

1. A computer-implemented method comprising:
obtaining at least one system-related documentation generation request;
identifying one or more context-based features of the at least one system-related documentation generation request;
determining one or more documentation templates, and one or more data objects corresponding thereto, to be used in connection with documentation generation by processing, using a first set of one or more artificial intelligence techniques, at least a portion of the at least one system-related documentation generation request and at least a portion of the one or more context-based features;
generating documentation in response to the at least one system-related documentation generation request by using at least a portion of the one or more documentation templates and at least a portion of the one or more data objects corresponding thereto in conjunction with a second set of one or more artificial intelligence techniques; and
performing one or more automated actions based at least in part on the generated documentation;
wherein the method is performed by at least one processing device comprising a processor coupled to a memory.

2. The computer-implemented method of claim 1, wherein determining one or more documentation templates and one or more data objects corresponding thereto comprises processing the at least a portion of the at least one system-related documentation generation request and the at least a portion of the one or more context-based features using at least one deep neural network-based (DNN-based) multi-target classifier.

3. The computer-implemented method of claim 1, wherein generating documentation comprises leveraging one or more generative artificial intelligence (GenAI) techniques and one or more retrieval augmented generation (RAG) techniques.

4. The computer-implemented method of claim 3, wherein generating documentation comprises:
retrieving from one or more data sources and using at least a portion of the one or more RAG techniques, the at least a portion of the one or more documentation templates and data pertaining to the at least a portion of the one or more data objects; and
providing the retrieved portion of the one or more documentation templates and the retrieved data to at least one large language model (LLM) associated with at least a portion of the one or more GenAI techniques.

5. The computer-implemented method of claim 4, wherein generating documentation comprises inserting, using the at least one LLM, the retrieved data into one or more designated sections of the retrieved portion of the one or more documentation templates.

6. The computer-implemented method of claim 1, wherein determining one or more documentation templates and one or more data objects corresponding thereto comprises identifying, by processing at least a portion of one or more documentation metadata data structures, one or more items of historical documentation associated with one or more requests sharing a designated level of similarity with the at least one system-related documentation generation request.

7. The computer-implemented method of claim 1, wherein identifying one or more context-based features of the at least one system-related documentation generation request comprises identifying one or more features pertaining to one or more users associated with the at least one system-related documentation generation request and identifying one or more features pertaining to one or more system-related elements associated with the at least one system-related documentation generation request.

8. The computer-implemented method of claim 1, wherein obtaining the at least one system-related documentation generation request comprises validating at least one entitlement of at least one user device associated with the at least one system-related documentation generation request.

9. The computer-implemented method of claim 1, wherein performing one or more automated actions comprises automatically outputting the generated documentation to one or more user devices associated with the at least one system-related documentation generation request.

10. The computer-implemented method of claim 1, wherein performing one or more automated actions comprises automatically training, using one or more portions of the generated documentation, one or more of at least a portion of the first set of one or more artificial intelligence techniques and at least a portion of the second set of one or more artificial intelligence techniques.

11. A non-transitory processor-readable storage medium having stored therein program code of one or more software programs, wherein the program code when executed by at least one processing device causes the at least one processing device:
to obtain at least one system-related documentation generation request;
to identify one or more context-based features of the at least one system-related documentation generation request;
to determine one or more documentation templates, and one or more data objects corresponding thereto, to be used in connection with documentation generation by processing, using a first set of one or more artificial intelligence techniques, at least a portion of the at least one system-related documentation generation request and at least a portion of the one or more context-based features;
to generate documentation in response to the at least one system-related documentation generation request by using at least a portion of the one or more documentation templates and at least a portion of the one or more data objects corresponding thereto in conjunction with a second set of one or more artificial intelligence techniques; and
to perform one or more automated actions based at least in part on the generated documentation.

12. The non-transitory processor-readable storage medium of claim 11, wherein determining one or more documentation templates and one or more data objects corresponding thereto comprises processing the at least a portion of the at least one system-related documentation generation request and the at least a portion of the one or more context-based features using at least one deep neural network-based (DNN-based) multi-target classifier.

13. The non-transitory processor-readable storage medium of claim 11, wherein generating documentation comprises leveraging one or more generative artificial intelligence (GenAI) techniques and one or more retrieval augmented generation (RAG) techniques.

14. The non-transitory processor-readable storage medium of claim 13, wherein generating documentation comprises:
retrieving from one or more data sources and using at least a portion of the one or more RAG techniques, the at least a portion of the one or more documentation templates and data pertaining to the at least a portion of the one or more data objects; and
providing the retrieved portion of the one or more documentation templates and the retrieved data to at least one large language model (LLM) associated with at least a portion of the one or more GenAI techniques.

15. The non-transitory processor-readable storage medium of claim 14, wherein generating documentation comprises inserting, using the at least one LLM, the retrieved data into one or more designated sections of the retrieved portion of the one or more documentation templates.

16. An apparatus comprising:
at least one processing device comprising a processor coupled to a memory;
the at least one processing device being configured:
to obtain at least one system-related documentation generation request;
to identify one or more context-based features of the at least one system-related documentation generation request;
to determine one or more documentation templates, and one or more data objects corresponding thereto, to be used in connection with documentation generation by processing, using a first set of one or more artificial intelligence techniques, at least a portion of the at least one system-related documentation generation request and at least a portion of the one or more context-based features;
to generate documentation in response to the at least one system-related documentation generation request by using at least a portion of the one or more documentation templates and at least a portion of the one or more data objects corresponding thereto in conjunction with a second set of one or more artificial intelligence techniques; and
to perform one or more automated actions based at least in part on the generated documentation.

17. The apparatus of claim 16, wherein determining one or more documentation templates and one or more data objects corresponding thereto comprises processing the at least a portion of the at least one system-related documentation generation request and the at least a portion of the one or more context-based features using at least one deep neural network-based (DNN-based) multi-target classifier.

18. The apparatus of claim 16, wherein generating documentation comprises leveraging one or more generative artificial intelligence (GenAI) techniques and one or more retrieval augmented generation (RAG) techniques.

19. The apparatus of claim 18, wherein generating documentation comprises:
retrieving from one or more data sources and using at least a portion of the one or more RAG techniques, the at least a portion of the one or more documentation templates and data pertaining to the at least a portion of the one or more data objects; and
providing the retrieved portion of the one or more documentation templates and the retrieved data to at least one large language model (LLM) associated with at least a portion of the one or more GenAI techniques.

20. The apparatus of claim 19, wherein generating documentation comprises inserting, using the at least one LLM, the retrieved data into one or more designated sections of the retrieved portion of the one or more documentation templates.
